(19) United States
(12) Patent Application Publication
(10) Pub. No.: US 2023/0294038 A1
(43) Pub. Date: Sep. 21, 2023

(54) SUSTAINABLE DESALINATION SYSTEMS AND METHODS

(71) Applicant: Enviro Water Minerals Company, Inc., Houston, TX (US)

(72) Inventor: Paul Steven Wallace, Austin, TX (US)

(21) Appl. No.: 17/997,710

(22) PCT Filed: May 5, 2021
(86) PCT No.: PCT/US2021/030948

§ 371 Date: Nov. 1, 2022

Related U.S. Application Data
(60) Provisional application No. 63/020,450, filed on May 5, 2020.
(60) Provisional application No. 63/065,776, filed on Aug. 14, 2020.

(51) Int. Cl. B01D 53/14; C02F 1/44; B01D 61/02; C01C 1/04; C01B 25/28; B01J 19/24; B01J 19/00

(52) U.S. Cl. CPC B01D 53/1475; B01D 53/1493; B01D 53/1425; C02F 1/441; C02F 1/442; B01D 61/025; B01D 61/027; B01D 61/029; C01C 1/0488; C01B 25/28; B01J 19/245; B01J 19/0006; C02F 2103/08

(57) ABSTRACT

The present disclosure is generally directed to a water processing system. In some embodiments, the water processing system may be configured to generate a potassium salt, such as potassium nitrate, an ammonium salt, such as ammonium nitrate, or both. In some embodiments, the water processing system may be at least partially powered by renewable energy, such as by using a liquid storage system that is at least partially underground. In some embodiments, the water processing system may be configured to reuse certain greenhouse emissions to improve performance of power generation systems associated with the water processing system.

### CROSS REFERENCE TO RELATED APPLICATION

This application is a national stage of PCT Application No. PCT/US20/45493, entitled “Sustainable Desalination Systems and Methods”, filed May 5, 2021, which claims priority from and the benefit of U.S. Provisional Patent Application No. 63/020,450, entitled “Sustainable Desalination Systems and Methods,” filed May 5, 2020, and U.S. Provisional Patent Application No. 63/065,776, entitled “Sustainable Water Processing Systems and Methods,” filed Aug. 14, 2020. Each of the foregoing applications is hereby incorporated by reference in its entirety.

### BACKGROUND

The subject matter disclosed herein generally relates to desalination systems, and more particularly, to a system for producing potassium and ammonium containing salt. Additionally, the subject matter disclosed herein relates to renewable energy systems included within the desalination system.

There are several regions in the United States (e.g., the southwestern United States including New Mexico, Southern California, and parts of Texas) and throughout the world that experience shortages in potable water supplies due, in part, to the arid climate of these geographic locales. As water supplies are limited, innovative technologies and alternative water supplies for both drinking water and agriculture may be utilized. One method for obtaining an alternative source of potable water uses desalination systems to produce the potable water.

The desalination process may involve the removal of salts from seawater, agricultural run-off water, and/or brackish ground water brines to produce potable water. Membrane-based desalination may use an assortment of filtration methods, such as nanofiltration and reverse osmosis, to separate the raw brine stream into a desalinated water stream and a tailing stream. The tailing streams may contain various salts and other materials left over after the desalination process. Included in these tailing streams may be valuable salts and minerals which may be extracted using membrane-based and/or evaporative techniques.

### BRIEF DESCRIPTION

The present disclosure generally relates to a system. In some embodiments, the system may include a desalination system configured to generate desalinated water from a seawater stream. The system may also include a gas separation and reaction system downstream from the desalination system. The gas separation and reaction system includes a hydrogen (H2) and oxygen (O2) production unit configured to generate an H2 stream and a first O2 stream electrolytically using the desalinated water. The gas separation and reaction system also includes an air separation unit configured to receive an air flow comprising nitrogen (N2) and O2, wherein the air separation unit is configured to generate a second O2 stream and an N2 stream based on the air flow. The gas separation and reaction system also includes a first ammonia production unit fluidly coupled to the H2 and O2 production unit and to the air separation unit, wherein the ammonia production unit is configured to generate an ammonia stream using the N2 stream and the H2 stream. The system also includes a second ammonia production unit fluidly coupled to the H2 and O2 production unit, wherein the second ammonia production unit is configured to receive a natural gas stream, the first O2 stream, and an additional air flow, and to generate ammonia based on the gas stream, the additional air flow, and the first O2 stream.

In another embodiment, the present disclosure relates to a system including an ammonia production system. The ammonia production unit includes a first ammonia production unit configured to produce a first ammonia stream using water as a first hydrogen gas source, wherein hydrogen gas of the first hydrogen gas source is electrolytically separated from the water. The ammonia production unit also includes a second ammonia production unit configured to produce a second ammonia stream using natural gas as a second hydrogen gas source. The system also includes an ammonium salt production unit fluidly coupled to the ammonia production system, wherein the ammonium salt production unit is configured to receive desalinated water, receive an acid stream, and receive an ammonia stream comprising the first ammonia stream, the second ammonia stream, or a combination thereof; and generate an ammonium salt stream based on the desalinated water, the acid stream, and the ammonia stream, wherein a pressure of the ammonium salt production unit is maintained within a pressure threshold range to substantially inhibit the ammonia from evaporating.

In another embodiment, the present disclosure relates to a system including an ammonia production system. The ammonia production system includes a first ammonia production unit configured to produce a first ammonia stream using water as a first hydrogen gas source, wherein hydrogen gas of the first hydrogen gas source is electrolytically separated from the water. The ammonia production system also includes a second ammonia production unit configured to produce a second ammonia stream using natural gas as a second hydrogen gas source. The system also includes a CO₂ recovery system. The CO₂ recovery system includes a chilled ammonia absorber system configured to receive the first ammonia stream, the second ammonia stream, or a combination thereof, and an exhaust gas stream, and to generate a CO₂ rich ammonia solution based on the ammonia stream and the exhaust gas stream. The CO₂ recovery system also includes a CO₂ stripper configured to generate a CO₂ lean ammonia solution and a CO₂ stream based on the CO₂ rich ammonia solution from the chilled ammonia absorber system.

In another embodiment, the present disclosure relates to a water nutrigation system. The water nutrigation system includes a desalination system configured to generate desalinated water from a seawater stream, wherein the desalination system comprises a nanofiltration (NF) system, and the NF system is configured to generate desalinated water and an NF concentrate stream based on the seawater stream. The water nutrigation system also includes a mineral recovery system downstream from the desalination system and configured to generate a mineral stream comprising calcium based on the NF concentrate stream. Further, the water nutrigation system includes an ammonia production system downstream from the desalination system and configured to generate ammonia based on the desalinated water. The ammonia production system includes a first ammonia production unit configured to produce a first ammonia stream using the desalinated water as a first hydrogen gas source, wherein hydrogen gas of the first hydrogen gas source is electrolytically separated from the desalinated water. The ammonia production system also includes a second ammonia production unit configured to produce a second ammonia stream using natural gas as a second hydrogen gas source. Further still, the water nutrigation system includes a first ammonium salt production unit downstream from the ammonia production system, wherein the first ammonium salt production unit is configured to generate ammonium nitrate based on the first ammonia stream, the second ammonia stream, or a combination thereof. Even further, the water nutrigation system includes a second ammonium salt production unit downstream from the ammonia production system, wherein the second ammonium salt production unit is configured to generate ammonium phosphate based on the first ammonia stream, the second ammonia stream, or a combination thereof. Even further, the water nutrigation system includes a nutrigation system configured to receive the ammonium phosphate, the ammonium nitrate, and the mineral stream and generate a mineralized water stream based on the ammonium phosphate, the ammonium nitrate, and the mineral stream.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of a first example of an ammonia production system, in accordance with aspects of the present disclosure;

FIG. 2 is a block diagram of a second example of an ammonia production system, in accordance with the present techniques;

FIG. 3 is a block diagram of a first example of a nitric acid production system, in accordance with the present techniques;

FIG. 4 is a block diagram of a second example of a nitric acid production system, in accordance with the present techniques;

FIG. 5 is a block diagram of a first example of a water processing system, in accordance with the present techniques;

FIG. 6 is a block diagram of an example of an ammonium phosphate production system, in accordance with the present techniques;

FIG. 7 is a block diagram of an example of a monoammonium phosphate production system, in accordance with the present techniques;

FIG. 8 is a block diagram of a second example of a water processing system, in accordance with the present techniques;

FIG. 9 is a block diagram of an example of a chilled ammonia system, in accordance with the present techniques;

FIG. 10 is a block diagram of a third example of a water processing system, in accordance with the present techniques;

FIG. 11 is a block diagram of an example of a power generation system, in accordance with the present techniques;

FIG. 12 is a block diagram of an liquid storage system that may be at least partially underground, in accordance with the present techniques;

FIG. 13 is a block diagram of an example of a flow of liquid between liquid storage tanks of the liquid storage system of FIG. 12, in accordance with the present techniques;

FIG. 14 is a block diagram of an example of the liquid storage system that includes an electrical resistance heater, in accordance with the present techniques;

FIG. 15 is a block diagram of a first example of a water processing system, in accordance with aspects of the present disclosure;

FIG. 16 is a block diagram of the water processing system of FIG. 15 with additional elements, in accordance with the present techniques;

FIG. 17 is a block diagram of a first example of a water storage system that may be incorporated into the water processing system of FIG. 15, in accordance with the present techniques;

FIG. 18 is a block diagram of a second example of a water storage system that may be incorporated into the water processing system of FIG. 15, in accordance with the present techniques;

FIG. 19 is a schematic diagram of an aerial view of a greenhouserecovery system that may be incorporated into the water processing system of FIG. 15, in accordance with the present techniques;

FIG. 20 is a schematic elevation view of a portion of the greenhouse recovery system of FIG. 19, in accordance with the present techniques;

FIG. 21 is a schematic diagram of a portion of the greenhouse recovery system of FIG. 19 that may be incorporated into the water processing system of FIG. 15, in accordance with the present techniques;

FIG. 22 is a schematic diagram of a supplemental cooling and heating system that may be incorporated into the water processing system of FIG. 15, in accordance with the present techniques;

FIG. 23 is a schematic diagram of a chiller system that may be incorporated into the water processing system of FIG. 15, in accordance with the present techniques;

FIG. 24 is a schematic diagram of a livestock system that may be incorporated into the water processing system of FIG. 15, in accordance with the present techniques;

FIG. 25 is a block diagram of a third example of a water storage system that may be incorporated into the water processing system of FIG. 15, in accordance with the present techniques;

FIG. 26 is a block diagram of a greenhouse capture system that may be incorporated into the greenhouse recovery system of FIG. 19, in accordance with the present techniques;

FIG. 27 is a block diagram of a thermal energy system that may be incorporated into the water processing system of FIG. 15, in accordance with the present techniques;

FIG. 28 is a schematic diagram of a solar energy system that may be incorporated into the water processing system of FIG. 15, in accordance with the present techniques;

FIG. 29A is a schematic aerial view of a first example of an aquaculture system, in accordance with the present techniques;

FIG. 29B is a schematic elevation view of the aquaculture system of FIG. 15A, in accordance with the present techniques;

FIG. 30 is a schematic aerial view of a second example of an aquaculture system, in accordance with the present techniques; and

FIG. 31 is a schematic diagram of an aquaculture system, in accordance with the present techniques.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Water Processing System Integration with Agriculture

The disclosed embodiments include a water processing system (e.g., a desalination system) that may generate certain chemicals for crop fertilization and nutrition. In general, geographic regions with arid climates typically may utilize desalination plants to provide fresh water for potable water systems and for agriculture. At least in some instances, agricultural consumption of water is much higher than potable water use and it is not always economical to provide desalinated water for agriculture. With high yield shadehouse or greenhouse agriculture (subsoil irrigation systems) it is possible to significantly increase crop yields per gallon of water consumed; however, this type of agriculture may utilize irrigation water with very low salt (NaCl) content. In addition, high purity fertilizers may be utilized that are fully consumed and do not leave dissolved salt residues in the soil that may utilize excess irrigation water for runoff water purging.

One important nutrient for fertilizers is potassium. Potassium may be supplied to crops from various potassium sources (e.g., salts), however, at least in some instances, the anion of the potassium source is not usable by the crops. For example, one potassium source is potassium chloride. It is noted that the chloride may not be consumed by the crops and may be purged with runoff water to prevent buildup in the soil. Another potassium source is potassium sulfate. In this case, excess sulfate be purged with runoff water to prevent buildup in the soil. Yet another potassium source is potassium nitrate. In this case, the crops may consume the nitrate that is associated with the potassium. However, potassium nitrate is relatively expensive and not readily available.

To improve crop yield per gallon of irrigation water it may be desirable to continuously add a low dosage of the correct fertilizer mix as a soluble component in the irrigation water. This may ensure that the fertilizer components are fully utilized and directly match the crop requirements during each stage of development. This may improve crop yield (e.g., reduce a likelihood of nutrient shortages), consume the fertilizers and nutrient minerals, and thus, purge water runoff to remove excess nutrients may not be utilized. However, in some embodiments, this system may utilize fertilizer components that are continuously added and adjusted so the supply of nutrients exactly matches crop consumption.

Many of the components that may be utilized for crop fertilization and nutrition can be produced from minerals recovered in a recovery desalination process in accordance with techniques of the present disclosure. In addition the salt (NaCl) content in all or a portion of the desalinated water from the disclosed recovery desalination process may be reduced by adding low cost BWRO membranes to the product SWRO permeate stream and preferentially routing the low NaCl containing evaporator condensate to irrigation.

Ammonia is an important feedstock for production of crop fertilizers. It is typically produced in large scale plants using CO₂ emitting fossil fuels (e.g., natural gas), and transported using additional fossil fuels to regional fertilizer plants for conversion and local distribution. It is desirable to produce the ammonia utilized for regional consumption locally using desalinated water and renewable power (e.g., electrolysis generated hydrogen) and nitrogen separated from air to produce ammonia. However, the high power consumption and low availability of renewable power has made onsite ammonia generation from renewable power uneconomical. Thus, it is presently recognized that a water processing system including the following features may allow agricultural production to work economically using desalinated water and the recovered minerals from desalinated water. In some embodiments, the water processing system may include low cost production of zero residue fertilizers using minerals recovered by the disclosed full recovery desalination process with minimal purchase of low cost external inputs. In some embodiments, the water processing system may produce and/or utilize multicomponent liquid fertilizers (e.g., fully water soluble) that can be continuously injected (and adjusted) into the subsoil irrigation water (fertigation). In some embodiments, the water processing system may produce and/or utilize low NaCl irrigation water from desalination that may reduce an amount if purging and runoff water utilized to prevent NaCl soil buildup. Further, the water processing system may provide local small scale production of ammonia feedstock from desalinated water, air, and renewable power.

### Ammonia Production

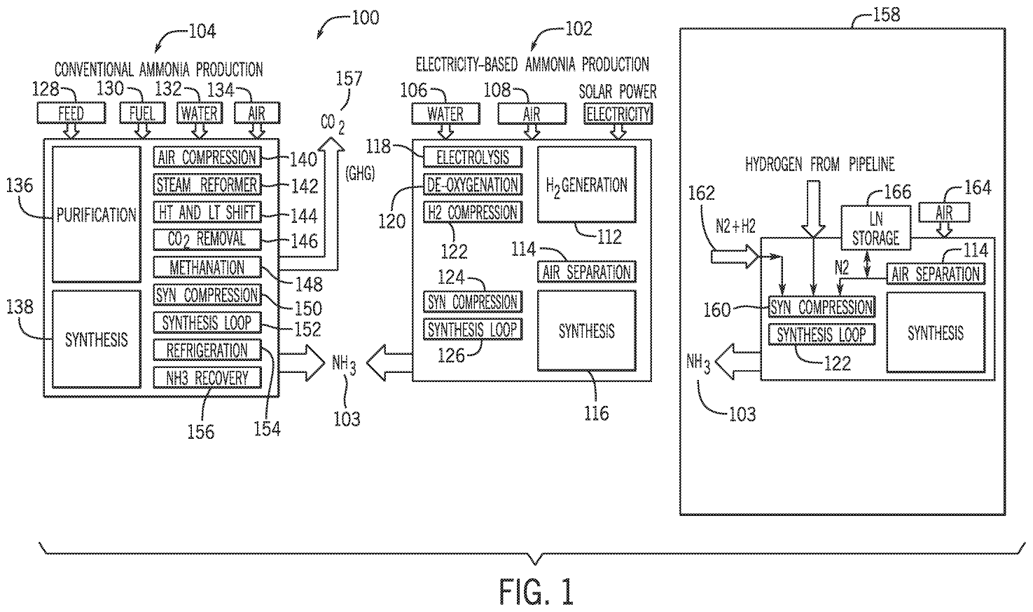

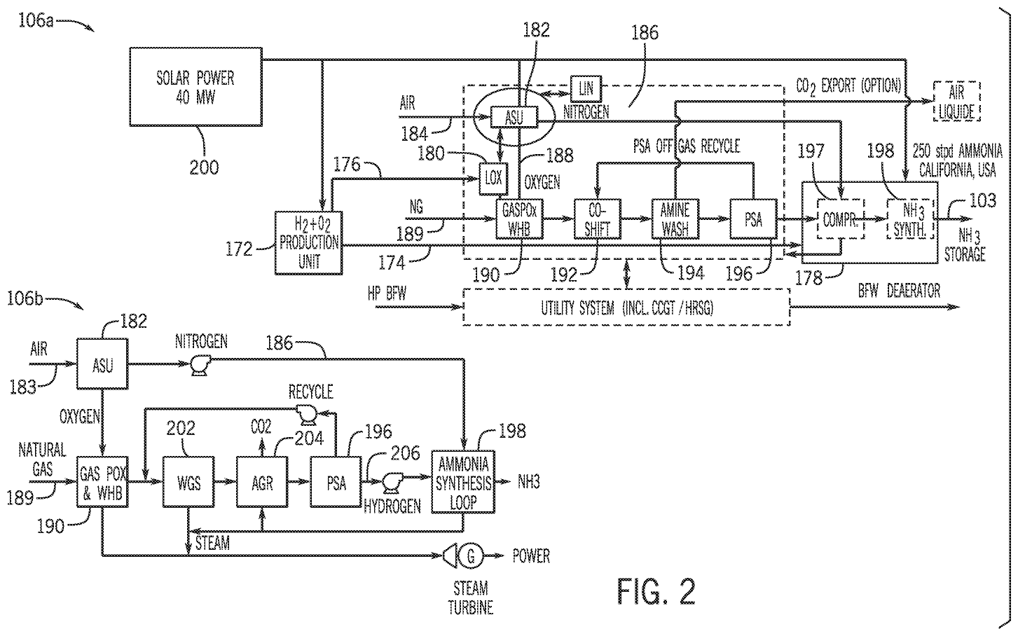

FIGS. 1 and 2 show block diagrams of ammonia production systems 10, which may be incorporated with the water processing system discussed herein. Ammonia (NH3) can be provided as an atmospheric refrigerated liquid (−28 F, −33° C.) delivered by ship, rail, or tanker truck to a refrigerated atmospheric bulk storage tank. Ammonia can also be generated onsite using natural gas, air and water to produce ammonia and byproduct or vented carbon dioxide. The onsite ammonia production is kept at production temperature of ˜40 F and is fed directly to solution fertilizer production, avoiding the transportation and storage as a refrigerated liquid.

Turning to FIG. 1, FIG. 1 is a block diagram of the ammonia production system 10, including a first ammonia production system 102 and a second ammonia production system 104. In general, the first ammonia production unit 102 and the second ammonia production unit 104 may each provide different onset generation methods of ammonia. For example, the first ammonia production system may generate ammonia using water and air (e.g., without natural gas), and the second ammonia production system may generate ammonia using natural gas. As shown in the depicted embodiment, the first ammonia production system 102 generates ammonia 103 using a water stream 106 and an air stream 108, as discussed in more detail with respect to FIG. 2. The water stream 110 may include desalinated water produced by a desalination plant. The first ammonia production unit 102 produces ammonia using a hydrogen generation step 112, an air separation step 114, and a synthesis step 116. For example, in certain embodiments, the hydrogen generation step 112 includes an electrolysis step 118, a deoxygenation step 120, and a hydrogen compression step 122. The synthesis step 116 includes a synthesis compression step 124 and a synthesis loop step 126. The first ammonia production system 102 may be at least partially powered via renewable energy sources such as solar power.

The second ammonia production unit 104 generates ammonia 103 using a feed source 128, a fuel source 130, a second water stream 132, and a second air stream 134. The second ammonia production unit 104 produces ammonia 103 using a purification step 136 and a synthesis step 138. For example, in certain embodiments, the purification step 136 includes an air compression step 140, a steam reformer step 142, a high temperature (HT) and low temperature (LT) shift step 144, a CO₂ removal step 146, and a methanation step 148. In certain embodiments, the synthesis step 138 includes a synthesis compression step 150, a synthesis loop step 152, a regeneration step 154, and an ammonia recovery step 156. As shown in the illustrated embodiment, the second ammonia production unit 104 also generates a greenhouse gas, such as CO₂ 157.

Additionally, FIG. 1 also includes a block diagram 158 that further illustrates the air separation step 114 and the synthesis step 116 described above with respect to FIG. 1. In the illustrated embodiment, a nitrogen gas and hydrogen gas stream 162 (e.g., hydrogen gas source) may be provided to a synthesis gas compressor 160 (e.g. associated with the synthesis compression step 120). At least in some instances, a second hydrogen gas stream 162 may be provided from a pipeline, storage tank, or other source. Additionally, nitrogen (N₂) may be supplied from a liquid nitrogen (LN) gas storage tank 166. In the illustrated embodiment, an air stream 108, 164 is provided to the air separation unit which may separate the air into an oxygen stream, a nitrogen stream, and other gas streams as described in more detail with respect to FIG. 2. In any case, the output of the synthesis gas compressor is provided to an ammonia synthesis production unit (e.g., associated with the synthesis loop step 126).

To further illustrate the features described above, FIG. 2 is a block diagram of an ammonia production system 106a. In general, the ammonia production system 106a produces an ammonia stream 103 using N₂ from air and H₂ gas from water (e.g., via the first ammonia production unit 102) and using O₂ from air, N₂ from air, and a natural gas (e.g., via the second ammonia production unit 104). In the illustrated embodiment, the ammonia production system 10a includes a hydrogen and oxygen production unit 172 that generates a hydrogen stream 174 and an oxygen stream 176, and this process is generally associated with the H₂ generation step 122 described above with respect to FIG. 1. The hydrogen and oxygen production unit 172 may include suitable catalysts or materials for electrolytically converting water into hydrogen (e.g. the hydrogen stream 174) and oxygen (e.g. the oxygen stream 176). The hydrogen stream 174 is directed to an ammonia reaction unit 178. The oxygen stream 176 is directed to an oxygen storage unit 180 (e.g., a liquid oxygen storage unit) that is fluidly coupled to an air separation unit 182.

The air separation unit 182 generally receives an air flow 184 (e.g. ambient air including oxygen and nitrogen) and separates the nitrogen and the oxygen from the airflow 184 into a nitrogen stream 186 and a second oxygen stream 188, and this process is generally associated with the air separation step 114 described above with respect to FIG. 1. The nitrogen stream 186 is directed to the ammonia reaction unit 178. The second oxygen stream 188 may be directed to an ammonia production unit that uses natural gas such as the second ammonia production unit 104.

The natural gas stream 189 (e.g., including the feed stream 128 and the fuel stream 130) are provided to a waste heat boiler (WHB) 190. At least in some instances, the WHB 190 may receive the second oxygen stream 188 produced by the air separation unit 182. The output of the WHB 190 is provided to the CO shift unit 192. Then, the output of the CO shift unit 192 is provided to an amine wash unit 194. Further, the output of the amine wash unit 194 is provided to the pressure swing absorption (PSA) unit 196, which may direct an off gas recycle back to the CO shift unit 192. Further still, the output of the PSA unit 196 is directed to the synthesis compression unit 197. The output of the synthesis compression unit 197 is provided to the ammonia synthesis unit 198 (e.g., the ammonia synthesis loop unit) whereby ammonia 103 is produced via suitable processes, such as the ammonia synthesis loop (e.g., the Haber-Bosch process), and this process is generally associated with the synthesis compression step 120, 150 and the synthesis loops step 122, 152 described above with respect to FIG. 1.

The ammonia production system 106b generally includes additional details with respect to the components associated with the second ammonia production unit 104. For example, the depicted embodiment of the ammonia production system 10b includes the WHB unit 190 that is upstream of and fluidly coupled to a Water Gas Shift (WGS) reaction unit 202. Additionally, the ammonia production system 10b includes an AGR unit 204 that is downstream from and fluidly coupled to the WGS unit 202. Further still, the ammonia production system 10b includes a PSA unit 196 that is downstream from and fluidly coupled to the AGR unit 204. The PSA unit 196 produces a hydrogen gas stream 206 that is output to the ammonia synthesis loop 198. Additionally, a recycle stream 207 may be routed upstream of the WGS reaction unit 202.

It should be noted that one or more components of the ammonia production system 10a may be powered by a renewable energy source such as a solar power energy source 200, as described in more detail below.

In some embodiments, ammonia may be produced onsite from solar power, air and water. This may block, prevent, or reduce CO₂ production or emissions in certain environmental conditions, such as when solar power is available (<40% availability). Thus, it results in intermittent ammonia production which causes a low utilization of the ammonia and solution fertilizer production equipment. In order to more fully utilize the ammonia and solution fertilizer production equipment the two onsite generation methods can be integrated.

During the day and night ammonia may be produced from natural gas at a base rate (70-90% of peak production). During the day solar power is used to produce additional electrolytic hydrogen and oxygen from water. The additional hydrogen is routed to the ammonia synthesis loop to increase daytime ammonia production to 100%. The additional oxygen is routed to liquid oxygen storage. During the day additional solar power is routed to the air separation unit to increase its capacity so that it can produce liquid oxygen and liquid nitrogen for storage, in addition to producing the oxygen and nitrogen utilized for peak ammonia production. Typically the air separation unit in partial oxidation (PDX) based ammonia generation is oxygen limited—a portion of the nitrogen is vented. With the addition of the oxygen from electrolysis the air separation unit can be designed to minimize venting of excess nitrogen. Ammonia production during the day is 100% of the peak flow since both the natural gas based hydrogen and electrolytic hydrogen are operating in parallel. In addition the air separation unit is operating at 100% of its design flow producing all the oxygen and nitrogen utilized for ammonia production in addition to the oxygen and nitrogen that are routed to liquid storage.

During the night the air separation unit is turned down to approximately 35-40% of its peak capacity. This may utilize 2-50% feed air compressors so that at least 1 air compressor may be operated at maximum efficient turndown (ie 70-80% capacity) during night time operation. Liquid oxygen and liquid nitrogen are taken from storage to supplement the oxygen and nitrogen production allowing the natural gas fed plant sections to generate the full design flow of hydrogen and nitrogen utilized to produce 70-90% of peak daytime ammonia production.

At least in some instances, the capacity of the air separation unit (i.e., the compressors of the air separation unit) may be modified (e.g., increased and decreased) by a controller. The controller includes a processor, which may execute instructions stored in a memory and/or storage media accessible by the controller, or based on inputs provided from a user via an input/output (I/O) device. The memory and/or the storage media may be read-only memory (ROM), random-access memory (RAM), flash memory, an optical storage medium, or a hard disk drive, to name but a few examples.

The liquid ammonia produced is let down from production pressure to approximately 100 psig (6.9 bar) and is maintained at 60-70 F, 100-110 psig (e.g., 6.8-7.5 bar) in a pressurized storage tank which holds a limited amount of ammonia (1-2 hours of ammonia production). A small ammonia gas compressor and a cooling water heat exchanger are used to maintain the refrigeration in the storage tank. Alternatively chilled water from circulating chilled water system can be used in a chilled water exchanger to condense the vaporized ammonia and maintain refrigerated conditions in the pressurized ammonia storage.

### Desalinated Water and Minerals Recovery

A portion of the product RO permeate and condensate may be pumped from the storage tank and routed to a brackish water reverse osmosis (BWRO) unit to remove 98-99% of the residual salt in the RO permeate to produce a high purity BWRO permeate with less than 50 mg/l TDS (mainly NaCl). A small amount of Mg(HCO₃)₂ and Ca(HCO₃)₂ solution from the storage tank is added to the BWRO permeate to produce an agricultural irrigation water stream with <50 mg/l NaCl and 100-150 mg/l HCO₃. A small amount of sulfuric acid is added to reduce the pH to 5.5-6 (if necessary). The BWRO concentrate with 1000-3000 mg/l TDS is recycled to the suction of the SWRO feed pump

The potassium chloride and gypsum may be conveyed or transported as moist washed solids from the desalination plant to minimize dust formation. The magnesium hydroxide is pumped as a slurry produced from a washed, moist (40-60% water content) filter cake which is finely ground.

### Ammonia Conversion to Nitric Acid

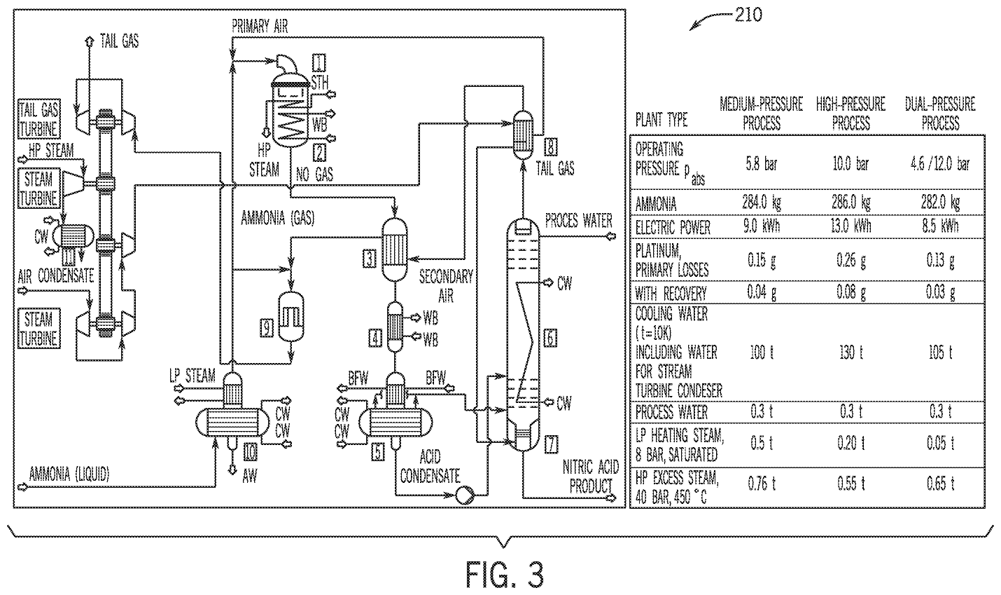

FIG. 3 shows a block diagram of an example of a potassium nitrate production system 180, which may be incorporated with the water processing system discussed herein. At least in some instances, a portion of the ammonia may be converted to nitric acid both for effective plant nutrition and to form a soluble nitrate salt with potassium to prevent chloride and sulfate buildup in the soil as explained in the problem section. A conventional ammonia to nitric acid plant may be used to convert a portion of the ammonia to nitric acid. Typically the medium pressure process would be used due to the small scale of production and the requirement for relatively dilute (60 wt % HNO₃) nitric acid utilized.

### Potassium Chloride Conversion to Potassium Nitrate and Hydrochloric Acid

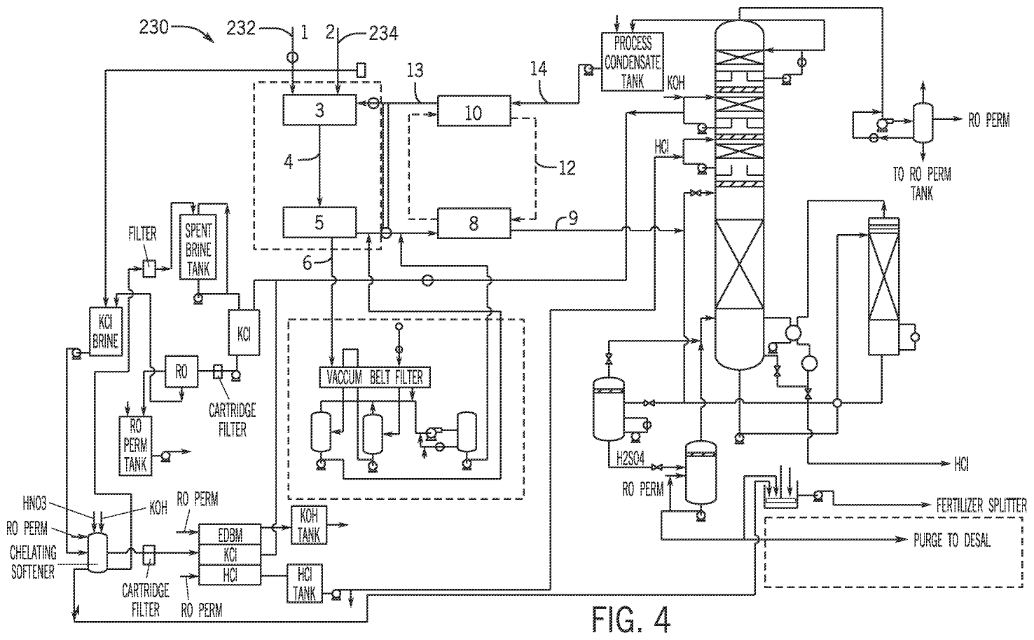

As a further non-limiting example, FIG. 4 is a block diagram of another example of a potassium nitrate production system 230. In one embodiment, a potassium nitrate slurry may be produced from a settler from 60 wt % nitric acid and potassium chloride from desalination.

In general, the potassium nitrate production system 230 receives a nitric acid stream 232 (e.g., 60 wt % solution) and a potassium chloride stream 234 (e.g., 98 wt %) that are provided to a cooled reaction vessel 3. The cooled reaction vessel 3 outputs a reaction stream 4 (e.g., HNO₃, KNO₃, HCl, KCl) to the settler 5. The settler 5 outputs a KNO₃ slurry stream 6 and a dissolved stream 7. The HNO₃ Absorber 8 (e.g., Liquid-Liquid Contactor) receives the dissolved stream 7 and a lean organic solvent stream 12 and outputs an acidic stream 9 (e.g., 20% HCl, 1.8% KCl, 0.5% CaSO₄, and 0.5% MgSO₄) that is fed to the feed flash section of the vacuum distillation column. The HNO₃ absorber also outputs an HNO₃+organic solvent 11 to the HNO₃ Desorber 10. The makeup water source 14 provided to the HNO₃ Desorber 10, and the Desorber 10 outputs a nitric acid containing stream 13 (e.g., 18.5% HNO₃, 5.5% HCl) to the cooled reaction vessel 3.

### KNO₃ Slurry Filtration

The product KNO₃ slurry (stream 6 in FIG. 4) filtered in a vacuum belt filter using internally produced reverse osmosis permeate (RO perm) in multiple washing stages. An optional hot air drier or mechanical press is used as a final filter stage to minimize water content and produce a moist cake suitable for transport on an enclosed belt conveyor with minimal dust production and no runoff water. The cool filtrate is routed to the settler outlet (unit 5 in FIG. 4). The warm filtrate from the final drying stage and the vacuum pump is routed to the settler outlet downstream of the heat exchanger.

### Vacuum Column

The 20 wt % HCl, 1.8 wt % KCl stream (stream 9 in FIG. 4) from the HNO₃ liquid-liquid contactor is mixed with the bottoms from the pressurized HCl product column and fed to a vacuum distillation column. The vacuum distillation column comprises a feed flash section, a distillation section that separates the feed into a water rich (low HCl) vapor stream and a 20-25 wt % HCl rich liquid, a dilute acid (3-5 wt %) scrubber that scrubs the HCl out of the water rich vapor stream, a dilute KOH (pH 8) scrubber that scrubs all residual HCl out of the water rich vapor stream, and a pump around condenser which uses a cooling water exchanger to condense the water vapor and any residual organic solvent in the feed and produce condensate that is routed to a process condensate tank. The process condensate (with the recovered organic solvent) and RO perm is used as the makeup water source 14 to the HNO₃ Desorber 10.

The non-condensables (air from vacuum leaks) from the top of the vacuum column are routed to a liquid ring vacuum pump that removes and vents the air. A small amount of makeup RO perm is routed to the liquid ring vacuum pump, and a small blowdown is taken back to the RO perm tank to prevent any buildup of acid or KCl salt in the vacuum pump circulating water stream.

### Pressurized Column

The concentrated HCl (22-24 wt %) from the bottom of the vacuum column is pumped to a heat exchanger which preheats the bottoms of the vacuum column and cools the bottoms of the pressurized HCl product column. The preheated vacuum column bottoms is fed to the pressurized product HCl column which produces a 35% HCl vapor overhead product stream and an 18-22 wt % bottoms stream which is routed to the heat exchanger described above and then mixed with the stream 9 in FIG. 4 and fed to the vacuum column as described above. MP steam (60-100 psig saturated steam) is fed to the reboiler of the pressured product HCl column to produce the 35 wt % HCl product vapor stream. Thus the vacuum column removes the water in the feed (stream 9 in FIG. 4) as condensate, and the pressurized column removes 35% HCl from the feed (stream 9 in FIG. 4).

The 35% HCl product vapor is routed to the reboiler on the vacuum column which provides heat for the vacuum column and condenses the 35% HCl product vapor into a 35% HCl product liquid. The 35% HCl product liquid is further cooled in a cooling water trim to cooler to below 100 F (e.g., 40° C.) and a portion routed to storage and truck, rail, or ship loading. The remaining cooled product 35% HCl is recycled back to the bottom of the vacuum column which is then pumped back to the 35% HCl pressurized product column as reflux.

KCl, CaSO₄, MgSO₄ Blowdown

A small portion of the bottoms from the pressurized product HCl column is routed to a near atmospheric (−1 to −2 psig) evaporator to remove dissolved KCl salt from the system and prevent scaling. A forced circulation evaporator is used to produce 15-25% HCl and water vapor which is recycled back to the bottom of the vacuum column along with a 10-20 wt % KCl slurry.

The 10-20 wt % KCl stream is mixed with 96% H₂SO₄ which converts it to HCl and K₂SO₄ and the mixture is routed to a two compartment vacuum (1.1-1.5 psig, 7.6-10 KPa) flash drum. In the top compartment HCl and water vapor are removed and recycled back to the bottom of the vacuum column. The concentrated K₂SO₄ brine and slurry from the first compartment is mixed with RO perm and recycled fully dissolved K₂SO₄ brine to fully mix and dissolve all the solids. A portion of the fully dissolved K₂SO₄ brine is recycled and the remainder is routed to mix tank where any residual acid is neutralized with magnesium hydroxide from desalination. The neutralized 20 wt % K₂SO₄ and 10 wt % MgSO₄ solution is used as a fertigation additive solution.

The KNO₃ salt and desalinated water is mixed with the 20 wt % K₂SO₄ and 10 wt % MgSO₄ solution to produce a fully soluble 20 wt % KNO₃ fertigation solution which contains 1-2 wt % K₂SO₄ and approximately 0.5-1 wt % MgSO₄.

### KCl Scrubber Blowdown

A dilute KCl stream (approximately 1 wt %) is purged from the KOH scrubbing section of the vacuum column to prevent KCl salt buildup in the scrubbing section. The dilute KCl stream is routed to KCl tank where it is mixed with recycled spent rinse water. The mixture from the tank is routed to an RO unit which produces RO permeate which is mixed with condensate from the vacuum column and makeup desalinated water in the RO perm tank. The water from the RO perm tank is used as makeup water for various uses (softener rinse water, EDBM makeup, vacuum pump makeup, stream 14 makeup, KNO₃ vacuum filter cake wash) as shown on the flow diagram.

The RO concentrate (3-5 wt % KCl) is routed to a chelating softener which removes any trace amount of calcium or magnesium, a cartridge filter which removes any trace amounts of insoluble and then to an electrodialysis bipolar membrane (EDBM) system. The EDBM extracts a portion of the KCl from the 4-5% KCl solution to produce a 2-3% KOH and a 2-3% HCl solution and a 1 wt % KCl solution. The 1 wt % KCl solution is recycled to the 1% KCl tank. The KOH solution is used for the scrubbing section of the vacuum column and to regenerate the softener. The HCl solution routed to the dilute HCl scrubbing section in the vacuum column.

The softener produces a small Ca(NO₃)₂ and Mg(NO₃)₂ purge stream which is combined with the 10% MgSO₄ and 20% K₂SO₄ fertilizer stream. The softener also produces a spent rinse stream which is routed to a bag filter, equalization tank and then back to the 1% KCl tank.

### Gypsum Solution

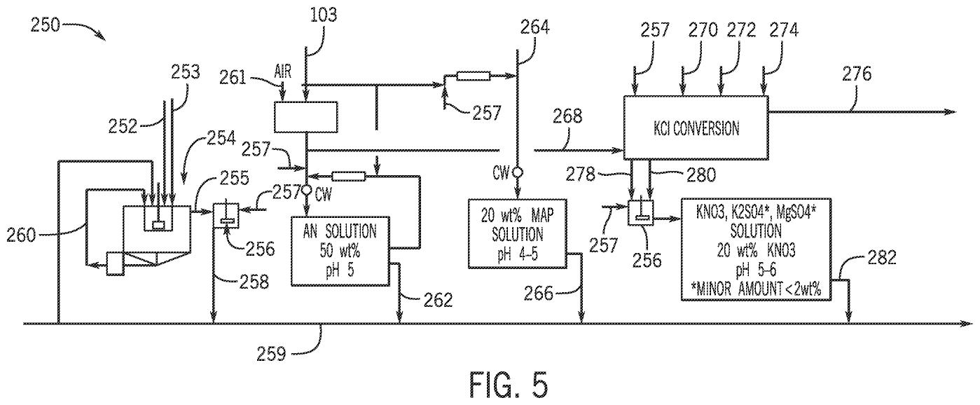

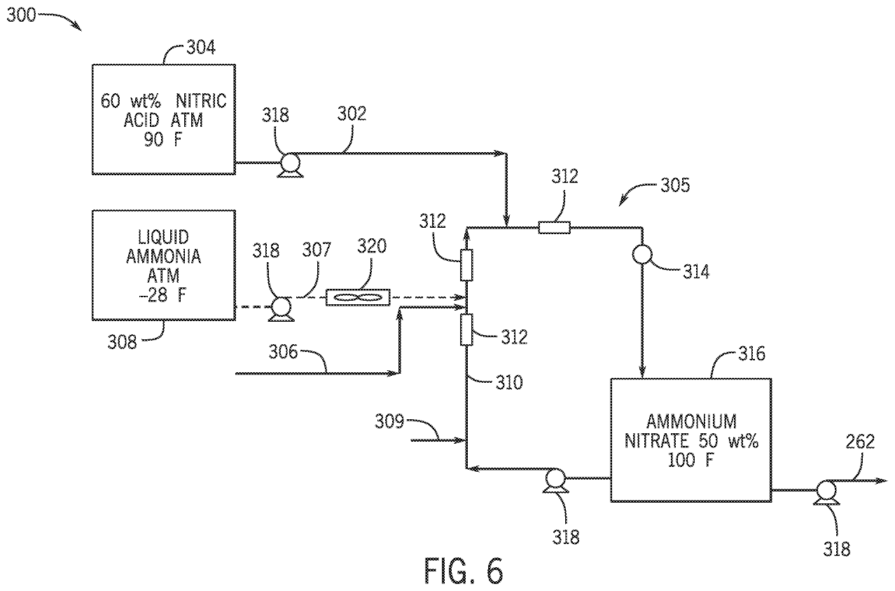

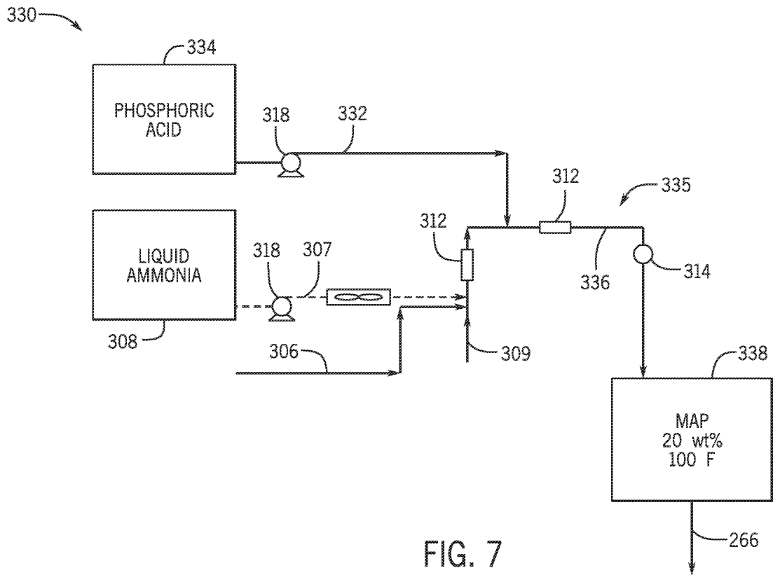

FIG. 5 is a block diagram of the water processing system 250 including an ammonium nitrate production system (e.g., a first ammonium salt production unit, a first ammonium salt production system) and a monoammonium phosphate production system (e.g., a second ammonium salt production unit, a second ammonium salt production system) as discussed in more detail with regards to FIGS. 6 and 7. The gypsum from desalination is routed to the inlet mixer section of a settler. Other trace nutrients ZnSO₄, CuSO₄ and MnSO₄ are mixed with the gypsum in the inlet mixer. The mixed sulfates are routed to the settling section and any undissolved solids settle out as settler bottoms. The settler overflow is routed to a mix tank where it is mixed with a small amount of desal water to produce a 90% saturated solution. The bottoms from the gypsum settler are routed to a high shear mixer and recycled back to the inlet mix section of the settler.

In the depicted embodiment of the water processing system 250 (e.g., water nutrigation system), gypsum 252 (e.g., produced by a desalination system), and sulfate-containing salts (e.g., ZnSO₄, CuSO₄, MnSO₄, in trace amounts) are provided to a gypsum mixer/settler 254. A first gypsum output 255 is provided to the mixer 256 where the first gypsum output 255 may be mixed with desalinated water 257 to produce a calcium sulfate stream 258 (e.g., 2000 ppm 90% sat.) The calcium sulfate stream 258 may be provided to desalinated water (e.g., 106) to generate a mineralized water stream 259 that receives additional minerals, as described below. The second gypsum output 260 may be recirculated back into the gypsum mixer/settler 254 to ultimately produce additional calcium sulfate for the calcium sulfate stream 258.

An ammonia stream 103 and an air stream 261 are used to produce ammonium nitrate 262, which is also added to the water stream 259. Additional details with regard to producing ammonium nitrate 262 are discussed with respect to FIG. 6. A phosphoric acid stream 264 and the ammonia stream 103 are used to produce monoammonium phosphate 266, which may also be added to the mineralized water stream 259. Additional details with regard to producing monoammonium phosphate 266 are discussed with respect to FIG. 7. A nitric acid stream 268 (e.g., produced using the combination of the ammonia stream 103 and the air stream 261), desalinated water 257, potassium chloride 270, magnesium hydroxide 272 (e.g., produced by the desalination system), and sulfuric acid 274 are used to generate HCl potassium nitrate 278, and a potassium sulfate and magnesium sulfate solution 280. The potassium nitrate 278 and the potassium sulfate and magnesium sulfate solution 280 are mixed (e.g., with a mixer 256) to generate a potassium source stream 282 (e.g., which may include some magnesium) that is also provided to the mineralized water stream 259.

### Ammonium Nitrate Production System

FIG. 6 is a block diagram for of an ammonium nitrate production system 300, which may be incorporated with the water processing system discussed herein. As noted above, ammonium nitrate is a key fertilizer component since crops typically may utilize nitrogen in the form of both nitrate and ammonia. However combining concentrated (60 wt %) nitric acid and liquid ammonia results in significant heat of reaction that can vaporize some of the ammonia or nitric acid causing it to be released to the atmosphere which causes smog and loss of fertilizer. Typically expensive specialized mixing equipment is utilized.

In the depicted embodiment, the ammonium nitrate production system 300 (e.g., ammonium nitrate production unit) directs a nitric acid stream 302 (e.g. 60 wt % nitric acid at 90 F, 32° C.) from a nitric acid source 304 (e.g. a storage tank) to a pressurized recirculation loop 305. Additionally, the ammonia nitrate production system 300 directs a first liquid ammonia stream 306 (e.g. ammonia 103) (e.g. 105 psig (723 KPa), 60-70 F, 15-20° C.) to the recirculation loop 305. Further, the ammonium nitrate production system 300 directs a second liquid ammonia stream 307 (e.g., 105 psig (723 KPa), 40 F, 5° C.) from a liquid ammonia source 308 (e.g., a storage tank storing liquid ammonia at −28 F under 1 atm) to the recirculation loop 305. A desalinated water stream 309 (110 psig, 90 F, 30° C.) is also directed to the recirculation loop 305. The nitric acid stream 302, the first liquid ammonia stream 306 and/or the second liquid ammonia stream 307, and the desalinated water stream 309 are mixed to generate an ammonium nitrate stream 310. As shown in the depicted embodiment, the recirculation loop 305 may include one or more mixers 312 (e.g. static mixers) to facilitate the mixing of the streams. The recirculation loop 305 may also include a cooling source 314 to provide temperature control of the ammonium nitrate stream 310. The ammonium nitrate stream 310 may be directed to an ammonium nitrate storage unit 316, where the ammonium nitrate may be stored for further use. As also shown in the depicted embodiment, the recirculation unit may include one or more pumps 318. The ammonium nitrate stream 310 may be stored or used as described herein.

However, an aqueous solution for fertigation can be produced onsite instead of remote production of a solid fertilizer, transportation to the site, and dissolving the solid in water to produce the solution. In order to produce 16 gallons-per-minute (GPM) of 50 wt % ammonium nitrate solution, 7.4 GPM of 100 F (e.g., 40° C.) product 50 wt % ammonium nitrate solution is pumped to 110 psig, and mixed with 3.5 GPM of 90 F (e.g., 32° C.) desalinated water in a static mixer. 1 GPM of liquid ammonia at 105 psig (723 KPa) and 40-60 F (e.g., 4-16° C.) is then added to the mixture in a second static mixer. At this point the free ammonia concentration is less than 15 wt % at 100 psig and 95 F (e.g., 35° C.) and is fully dissolved in the solution.

3.9 GPM of nitric acid (60 wt %) is added to the mixture in a static mixer which heats the mixture to 190 F (e.g., 88° C.). Since the mixture is at a pressure of 95 psig (655 KPa) all of the components stay in the liquid phase. The hot mixture is then cooled in a heat exchanger at 95-90 psig to 100 F (e.g., 40° C.) using cooling water. The cooled mixture (15.7 GPM) is then letdown through an expander or valve into a product 50 wt % ammonium nitration solution tank. The amount of nitric acid is adjusted so that the pH of the product solution remains in the range of 4.5-5.5 avoiding ammonia or nitric acid emissions from the tank. The net production of 8.3 GPM is then fed to the crop irrigation system. The flow rates of each component given are an example, they are varied in the same proportions so that the average production matches the average consumption based on long term tank level control.

### Monoammonium Phosphate Production (MAP) System

FIG. 7 is a block diagram for of a monoammonium phosphate (MAP) production system 330, which may be incorporated with the water processing system discussed herein. Monoammonium phosphate may be prepared as a dilute solution due to its relatively low solubility at low ambient temperatures (25 wt % solution at temperatures less than 50 F (e.g., less than 10° C.). Thus it is typically produced remotely and transported as a solid fertilizer, and mixed with water on site to produce a fertilizer solution.

In the depicted embodiment, the monoammonium phosphate production system 330 (e.g., monoammonium phosphate production unit) directs a phosphoric acid stream 332 (e.g. 70 wt % phosphoric acid at 90 F, 30° C.) from a phosphoric acid source 334 (e.g. a storage tank) to a pressurized flow path 335. Additionally, the monoammonia phosphate production system 330 directs a first liquid ammonia stream 306 (e.g. ammonia 103) (e.g., 105 psig (723 KPa), 60-70 F, 15-20° C.) to the flow path 335. Further, the monoammonium nitrate production system 300 directs a second liquid ammonia stream 307 (e.g., 105 psig (723 KPa), 40 F, 5° C.) from a liquid ammonia source 308 (e.g., a storage tank) to the flow path 335. A desalinated water stream 309 (110 psig (758 KPa), 90 F, 30° C.) is also directed to the flow path 335. The phosphoric acid stream 332, the first liquid ammonia stream 306 and/or the second liquid ammonia stream 307, and the desalinated water stream 309 are mixed to generate a monoammonium phosphate stream 336. As shown in the depicted embodiment, the flow path 335 may include one or more mixers 312 (e.g. static mixers) to facilitate the mixing of the streams. The flow path 335 may also include a cooling source 314 to provide temperature control of the monoammonium phosphate stream 336. The ammonium phosphate stream 336 may be directed to a monoammonium phosphate storage unit 338, where the monoammonium phosphate may be stored for further use. As also shown in the depicted embodiment, the recirculation unit may include one or more pumps 318. The monoammonium phosphate stream 266 be stored or used as described herein.

However, an aqueous solution for fertigation can be produced onsite. 39.3 GPM of desalinated water at 90 F and 105 psig (723 KPa) is mixed with 1 GPM of liquid ammonia at 40-60 F in a static mixer. This produces a mixture with <5 wt % free ammonia at 100 psig and 90 F where the ammonia is fully dissolved in the water. 5.3 GPM of merchant grade phosphoric acid (75 wt % H3PO4) is added in a static mixer which increases the temperature to 120 F (e.g., 49° C.) at 95 psig (655 KPa). Since the mixture is at a pressure of 95 psig (655 KPa) all of the components stay in the liquid phase.

The hot mixture is then cooled in a heat exchanger at 95-90 psig to 100 F (e.g., 40° C.) using cooling water. The cooled mixture (45.6 GPM) is then letdown through an expander or valve into a product 20 wt % monoammonium phosphate solution tank. The amount of phosphoric acid is adjusted so that the pH of the product solution remains in the range of 4-5 avoiding ammonia emissions from the tank. The net production is then fed to the crop irrigation system. The flow rates of each component given are an example, they are varied in the same proportions so that the average production matches the average consumption based on long term tank level control.

### Fertigation Continuous Blending

The fertigation solution produced as described above (e.g., utilizing the gypsum solution, ammonium nitrate solution, monoammonium phosphate solution, and potassium nitrate solution shown in FIG. 5) may be continuously blended into the irrigation water to provide the optimum nutrient mixture for each crop's growth period. The multicomponent fertilizer solutions may allow different nutrient mixtures to be generated online based on the crop being irrigated. This may allow a single fertigation system to serve a large and varied agricultural production system with crops at various stages of production.

It is also recognized that the disclosed techniques may enable production of continuously optimized near zero residue simultaneous irrigation and fertilization using desalinated water and mainly minerals recovered from desalination. For example, merchant grade phosphoric acid and a small amount (<1% of the total fertilizer input) of 96% sulfuric acid from outside sources may be used. Further, Fertilizer grade KCl from desalination may be converted into a KNOB based fertilizer solution and merchant grade 35% HCl. This may allow the chloride to be sold as HCl instead of creating a chloride residue in the soil which would utilize additional irrigation water and would produce a chloride rich agricultural water runoff stream. Additionally, the fertigation system produces multiple liquid fertilizer solutions whose proportion can be continuously adjusted to provide optimal crop nutrition to multiple crops at different growth stages. Further still, due to the near zero residue and continuous control of nutrients and water there is no requirement for agricultural runoff water to purge excess fertilizers and fertilizer residues from the soil. This may also reduce the irrigation water requirement to a minimum for optimal water use yield (i.e., lb crop/gal water or kg crop/L water). Even further, the fertigation system may allow high efficiency subsurface (no soil evaporation loss) drip irrigation systems to supply all the water and fertilizer requirements since all fertilizers and minerals are 100% water soluble and fed in the form of clear liquid solutions (no plugging of drip emitters). Even further, the NF concentrate, mag brine and RO concentrate MVR brine concentrators all use storage tanks and excess MVR capacity which may allow operation of the MVR brine concentrators to be matched with PV daytime power. This may reduce utilization storage batteries and may allow lower cost but lower availability PV power to be used for approximately 60% of the total power utilized for the full recovery desalination process.

Water Processing System Integrated with Solar and Wind Power

In another embodiment, the disclosed embodiments include a water processing system (e.g., a desalination system) that is at least partially powered by renewable energy sources. Certain geographic regions may not have access to fresh water sources. For example, geographic regions having arid climates and/or semi-arid climates may have access to water containing salt at relatively higher levels than fresh water, such as brackish water, saline water, or brine. These geographic regions may utilize desalination plants to provide fresh water in addition to heating and cooling needs such as summertime building cooling for climate control and greenhouses with summertime evaporative cooling and wintertime heating to provide food. However, operating the desalination plants and providing the heating and cooling may utilize significant electrical power. It is presently noted that geographic regions having arid-climates, such as the geographic regions around the Arabian Peninsula, may have access to certain renewable energy sources, such as solar power resources. For long term sustainable operation of the desalination plants and the heating and cooling needs, it is desirable to use renewable energy sources that are non-CO₂ emitting (e.g., solar-powered, wind-powered, and the like).

Certain desalination plants, such as desalination plants having membranes and minerals recovery may operate for relatively long periods of time (e.g., 1 hour, 2 hours, 4 hours, 8 hours, 12 hours, and/or 24 hours each day during a week) in order to maximize water and byproduct minerals revenue from the large fixed capital investment. In addition, the membrane units (nanofiltration and reverse osmosis) can dry out or foul if they are cycled on an unplanned basis.

The commercial and residential power demand for building cooling can be backed up during cloudy days (lower cooling demand) by cold water storage (thermal energy storage district cooling systems—see EWM Integration of Solar and Wind Power with Desalination disclosure). At least in some instances, the cooling demand may be seasonal (approximately 6-7 months per year). For example, during the winter there may be excess renewable power available during relatively cooler periods of time as there may be no heating demand for these regions, such as regions located near seas and oceans. This is a problem for renewable power systems because there may be too little power available to meet the peak summer cooling demand and excess power produced in winter (no cooling demand).

The geology around certain geographic regions having arid climates, such as the Red Sea, Gulf of Aden, Gulf of Oman coasts may certain features including coastal cities with ports and access to seawater for desalination, elevated (>1000 ft elevation) inland areas within 20-40 miles of the coast with open low cost land, improved solar resources, improved mountaintop (elevated) wind resources, and relatively drier climates that may facilitate energy efficient evaporative cooling. Thus, there is a need to cost effectively integrate the coastal desalination plant and summertime building cooling with remotely located (higher elevation, more arid) greenhouses, solar power plants, and wind power plants so that all the elements function as a high availability economically viable system.

### Desalination Plant

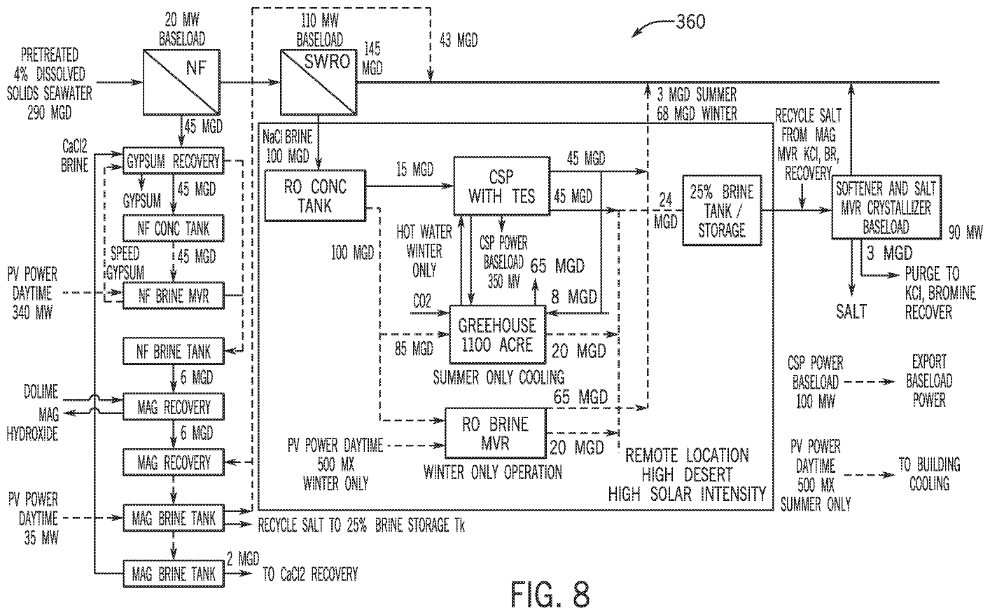

FIG. 8 shows a block diagram of a water processing system 360 (e.g., a desalination plant), in accordance with the present techniques. The desalination plant may include an intake and pretreatment system (not shown) where seawater is screened, filtered and optionally treated with dissolved air flotation (fine solids removal), biologically active carbon filter (organics removal), and microfiltration (carbon fines removal). Acid injection and a degasifier is used to remove essentially all the alkalinity in the seawater. The essentially solids, organics and alkalinity free seawater containing approximately 4 wt % dissolved solids is pumped to a low pressure (<200 psig 1380 KPa) nanofiltration (NF) membrane system to produce calcium, magnesium and sulfate rich NF concentrate for calcium, magnesium and sulfate recovery and NF permeate.

### NF Concentrate

A reactor (pH<5, >30 minute residence time, well mixed with sparger or agitator), settler (pH 9.0-9.5) and settler bottoms filter (vacuum drum or belt) produces an agricultural gypsum grade washed and dried (<15 wt % free water) filter cake.

Seed gypsum purge slurry from a downstream NF brine mechanical vapor recompression (MVR) evaporator is also fed to a separate vacuum belt filter. The filter cake is recycled to the reactor to provide unpoisoned (NF antiscalant free) gypsum seed crystals to minimize gypsum supersaturation in the settler overflow. Some of the filtrate is recycled to the NF brine MVR and the remainder is routed to an NF brine tank as an evaporator blowdown to control total dissolved salts to <30 wt % to reduce boiling point rise in the MVR evaporator.

The gypsum recovery settler overflow is routed to an NF concentrate tank which holds 12-36 hours of NF concentrate. During daytime when there is photovoltaic power (PV) available the NF concentrate is fed from the tank to the NF brine MVR evaporator. A 5-15 wt % gypsum seed crystal concentration in the brine is maintained in the recirculating brine in the MVR tubes to minimize gypsum scaling (see GE MVR powerpoint presentation). A sufficient brine blowdown to the gypsum recovery section is taken to maintain the optimal gypsum concentration to prevent both scaling of the tubes and plugging of the recirculating concentrate.

The brine from the NF brine tank is routed to magnesium recovery (dolomitic lime reaction and magnesium hydroxide precipitation settling and filtration). The brine from magnesium recovery is routed to a magnesium recovery brine tank which holds 12-36 hours of magnesium recovery brine. During daytime when there is PV power available the magnesium recovery brine is fed from the tank to the magnesium recovery brine MVR. A standard single compressor MVR can be used with a high compression ratio or a 2 stage system can be used to compensate for the high boiling point elevation (e.g., >30 F, >−1° C.). A 5-15% sodium chloride seed crystal concentration in the brine is maintained in the recirculation MVR tubes and basin to minimize salt scaling. A salt centrifuge may be used to continuously remove salt and maintain the desired sodium chloride seed crystal concentration. The concentrate (e.g., >35 wt % CaCl2 brine) is routed to calcium chloride recovery (MP steam evaporator and fired drier).

### NF Permeate

The NF permeate containing mainly sodium chloride and water is pumped to high pressure (>1000 psig, 69 bar) seawater reverse osmosis (SWRO) membranes to produce 7-8 wt % sodium chloride rich brine and desalinated water.

### SWRO Concentrate

The 7-8 wt % sodium chloride brine is continuously pumped to an optionally remote tank, which is located adjacent to the solar power facilities (e.g., concentrated solar power—CSP, PV solar power) greenhouse, and wind generation facilities. Ideally the solar power generation location is significantly above sea level (e.g., >1000 feet). This provides improved solar radiation for the solar power generation, drier air for the greenhouse (i.e., which may allow effective evaporative cooling without over humidifying the greenhouse), and improved wind resource during cloudy and stormy weather.

### CSP Power—Summer and Winter Operation

The CSP solar power plant is operated year round in baseload configuration with hot oil or molten salt storage which may allow for relatively long periods of time (e.g., 1 hour, 2 hours, 4 hours, 8 hours, 12 hours, and/or 24 hours each day during a week) baseload power generation. A backup/supplemental natural gas fired heater can optionally be used to provide additional redundancy or reduce hot oil or molten salt storage. Instead of using a standard closed steam and condensate cycle a once through steam generation (OTSG) system is used which deaerates and preheats the soft (e.g., <50 mg/l Ca, <40 mg/l Mg) near alkalinity and sulfate free (e.g., <10 mg/l HCO₃, <10 mg/l SO₄) RO concentrate from NF permeate as feed water to the boiler. Titanium tubes or plates are used in feed water heaters in brine service to prevent corrosion. The boiler drum is titanium clad to prevent corrosion. A single reheat cycle with steam turbine extraction steam preheaters is used to maximize preheat to the brine, maximizing steam production. The RO concentrate boiler may operate at 500-1000 psig (e.g., 34-69 bar) and the steam routed through an irrigated demister where it is washed with a small amount (e.g., <2%) of steam condensate from the preheaters. The saturated steam is then routed to a superheater, high pressure steam turbine, reheater, medium pressure to condensing steam turbine.

### Steam Turbine Condenser

Airfan condensers operating at 2.5-3 psig (130-140 F, 55-60° C.) condense the steam from the steam turbine to produce warm condensate (desalinated water). During winter circulating pumps pump warm (130-140 F, 55-60° C.) water from the warm condensate collection drum through the greenhouse back to the condensate drum to provide greenhouse heating. The fan speed on the airfan condensers is reduced and a condenser bypass valve is opened during winter conditions which may allow a portion of the waste condenser heat to be used to heat the greenhouse. Typically, up to 50% of the available condenser heat is used to heat the greenhouse in winter. Greenhouse size is typically limited by the availability of RO concentrate used for evaporative cooling in the summer. The warm condensate from the airfan condensers along with the extraction steam preheater condensate is then used to preheat the RO concentrate and produce near ambient temperature (<100 F, <40° C.) desalinated water.

### Boiler Blowdown

The boiler blowdown is flashed to 150 psig (10 bar) in a titanium clad blowdown drum to produce additional preheat steam and concentrate the salt to near (90-95%) saturation. The brine is then used to preheat RO concentrate to the boiler. It is cooled to near ambient (<100 F, <40° C.) and routed to the nearby 25% brine storage tank.

### Greenhouse

In order to maximize water efficiency (lb crop/gallon water, kg crop/L water) and crop yields (lb or kg crop/acre), the greenhouse may be cooled in the summer and heated in the winter. In addition, carbon dioxide may be added to the greenhouse which may allow optimum yields from high density plantings. Year-round crop production is utilized to maximize the return of the fixed investment of the greenhouse.

### Summer Operation

As a non-limiting example, during periods of time where the air temperature is relatively warmer (e.g., daylight temperatures greater than 25 degrees Celsius). During summer the RO concentrate may be pumped from the tank during daytime to an evaporative cooler. This comprises a filtered ambient air blower, an FRP, HDPE or PVC vessel equipped with polypropylene, or FRP packing, sprays and a demister pad to contact the air and RO concentrate counter currently. This may allow the air leaving the top of the contactor to be saturated at near fresh water equilibrium conditions and the RO concentrate leaving the bottom of the contactor to be near (e.g., approximately between 90-95%) of saturated salt condition. Typically, 10-20% of the air from the blower will bypass the evaporative cooler to control the amount of cooling and limit the outlet greenhouse relative humidity to <80% and the dry bulb temperature to between 75-85 F (e.g., 24-30° C.). The properly cooled air is then routed to a distribution system inside the greenhouse to provide uniform cooling. Multiple evaporative coolers may be used to provide adequate cooling. The RO brine at 90-95% salt saturation from the evaporative cooler is routed to the nearby 25% brine storage tank. The storage tank is sized for 16-20 hours of capacity which may allow a high rate of brine production during daytime and a lower rate at night. At least in some instances, the night greenhouse temperature target is 65 F for optimal crop growth and, thus, day and night cooling may be utilized during the hottest summer months (e.g., June to September).

Locating the greenhouse at the sea level location may not allow evaporative cooling to cool the greenhouse. The high ambient humidity during the peak summer conditions may utilize energy intense and expensive mechanical cooling (e.g., air conditioning) to cool the air without adding humidity, which is typically not economical for greenhouses.

### Winter Operation

During winter operation there is minimal air circulation through the greenhouse, and thus carbon dioxide makeup is critical for optimal yields. Carbon dioxide may also be helpful during summer operation since it prevents localized depletion of atmospheric carbon dioxide. As discussed above waste airfan condenser heat from the steam turbine condenser of the CSP system is used to heat the greenhouse to above 65 F (e.g., 18° C.) at night and above 75 F during daytime.

### Irrigation

The optimized seawater cooling and ventilation of the greenhouse in summer and winter heating (minimal ventilation) provide optimal growing conditions (dry bulb temperature and humidity) inside the greenhouse. A relatively small amount of desalinated water from the CSP production may be utilized for crop irrigation versus that may be utilized for evaporative cooling (8 gallons of evaporative cooling for every gallon of irrigation water). Using RO concentrate to cool and condition the greenhouse, and using a portion of the CSP byproduct condensate may allow the greenhouse to operate highly productively with essentially no fresh water consumption and no energy consumption for winter heating.

### RO Brine MVR

During winter (low ambient dry bulb temperature conditions) operation of the greenhouse no or reduced RO concentrate may be evaporated in the greenhouse evaporative cooler. However, there may be no daytime cooling demand during the typical 5-6 month winter period. Thus, the excess winter daytime PV power can be used to produce desalinated water. This can be used in daytime operated MVR brine concentrators to produce near saturated sodium chloride brine (90-95%) and desalinated water. The desalinated water can be used to recharge the local aquifer so that fresh ground water is available during summer months without the losses typically associated with surface fresh water storage. High desert locations frequently have aquifers where “fossil water” (water from previous ice ages) has been depleted for conventional outdoor agriculture. These remote aquifers can be cost effectively recharged during the winter using PV power that otherwise may not be useable. Unlike the aquifers located near the ocean (i.e., aquifers below sea level and close to the ocean), they are typically located above sea level or remote from the ocean and not subject to salt water intrusion.

In some embodiments, the MVR brine concentrators may only be used during daytime (˜40% of the time), and thus, the RO concentrate and 25% brine tank would be sized which may allow continuous filling and discharge of the tank, but daytime only operation of the MVR brine concentrators.

### Salt Brine and Salt MVR

The near saturated (˜25 wt %) sodium chloride brine is continuously routed from the tank back to the full recovery desalination for sodium chloride salt and other monovalent mineral recovery (potassium chloride, bromine, lithium etc). Pressure exchangers on the 25 wt % brine may be used to provide pumping energy for the RO concentrate to minimize the pumping energy may be utilized to get the feed RO concentrate up to the elevation of the CSP, PV, greenhouse, RO concentrate MVR site.

Recycle salt from the CaCl2 MVR brine evaporator and downstream mineral recovery is added to the brine to increase the sodium chloride brine saturation to 98-100%. A membrane based brine softener is used to fully soften the saturated brine and a baseloaded MVR crystallizer is used to recover the bulk of the water and produce high purity chemical grade sodium chloride salt. A purge from the MVR crystallizer provides feed brine to the downstream potassium chloride, bromine, lithium etc. recovery units.

### Wind Power

During winter months stormy conditions can reduce CSP and PV power since overcast or cloudy conditions can occur. Typically, during the overcast conditions high wind power production can occur. Thus, the increased wind power offsets the reduction in solar power during the winter storms or cloudy conditions. In addition, the RO Brine MVR brine concentrators can be used as a swing load to deal with any short term power production shortfalls. The RO concentrate tank would be sized to handle the worst case conditions allowing the excess wind power to be used in the RO Concentrate MVR brine concentrators as catchup during nighttime conditions. The combination of CSP power with hot oil or molten salt storage, RO concentrate MVR brine concentrator load management, and wind power should allow renewable power to be used for essentially all the utilized power generation with only minimal backup natural gas fired power (emergency power only).

Ammonia and Nitric Acid Production with Byproduct HP Steam and Oxygen

As part of the full recovery desalination plant solar fueled ammonia can be produced. A byproduct of the solar ammonia is oxygen, which is produced during water hydrolysis (hydrogen production) and during nitrogen production (cryogenic air separation). All or a portion of the solar ammonia can be reacted (combusted) with air to produce nitric acid and high pressure steam which can be used to evaporate the calcium chloride brine to approximately 70 wt %. This combustion process does not produce CO₂ and also provides nitric acid. The nitric acid can be combined with the solar based ammonia to produce ammonium nitrate fertilizer, or reacted with recovered potassium chloride to produce high value potassium nitrate fertilizer and hydrochloric acid.

### Magnesia Kiln

The magnesium hydroxide recovered from the NF brine may be dried and calcined to be able maximize its market value and cost effectively ship it as a water free commercial commodity product. A natural gas fired kiln is used to dry and calcine the magnesium hydroxide. Byproduct oxygen can be used to reduce natural gas consumption (increase kiln energy efficiency) and produce a flue gas that is higher in CO₂ concentration and lower in nitrogen concentration. Flue gas recirculation (e.g., using a fuel gas recirculation system) can also be used which may allow increased oxygen consumption and reduced makeup air, which further increases CO₂ concentration in the kiln exhaust gas.

### Chilled Ammonia CO₂ Capture

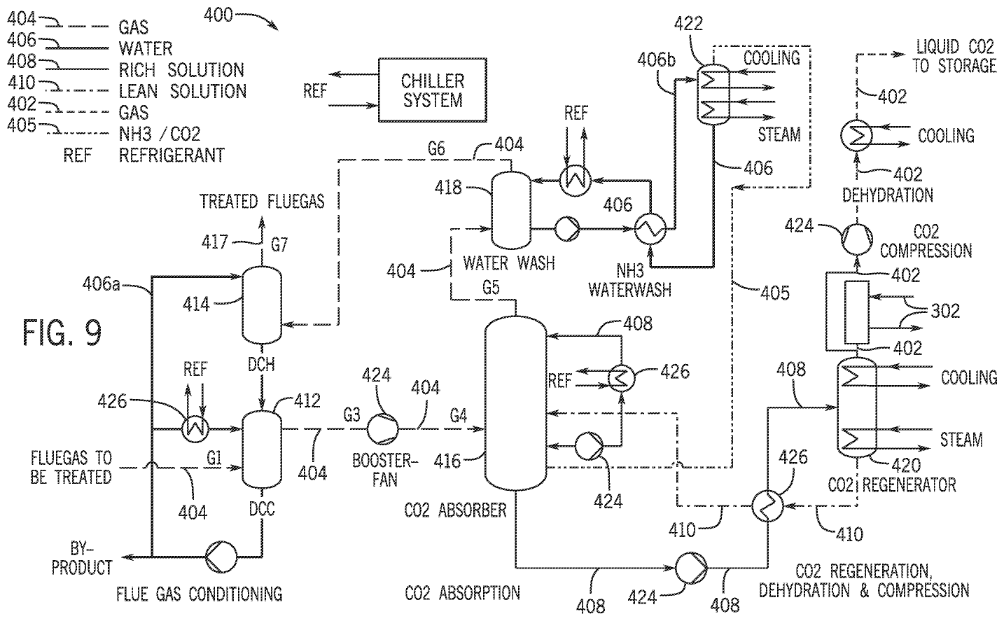

FIG. 9 shows an example of a chilled ammonia system 400, which may be incorporated with the water processing system as discussed herein. The chilled ammonia system 400 can be used to capture a portion (25-40% depending on flue gas recycle, oxygen injection and kiln efficiency) of the net CO₂ emitted from the kiln. The CO₂ rich solvent may then be pumped to the remote greenhouse and CSP location. Additional LP (50-150 psig. 3-10 bar) steam is extracted from the CSP steam turbine during daytime operation to regenerate the chilled ammonia and provide CO₂ to the greenhouse during daytime. A CO₂ scrubber can be added to the standard chilled ammonia system to ensure that there is no residual ammonia in the CO₂ routed to the greenhouse. The irrigation water (acidified to pH 5 with nitric acid) is used to scrub the ammonia out of the CO₂. Additional nitric acid can be used to acidify the product irrigation water to the optimal value (typically pH 6). The residual ammonia is converted to a trace amount of ammonium nitrate in the irrigation water which is a fertilizer. Makeup solar ammonia is added to the absorber section to maintain ammonia concentration in the CO₂ absorption solvent.

In general, the chilled ammonia system 400 (e.g. the CO₂ recovery system 400) extracts CO₂ from an exhaust gas stream 404 produced by components of the water processing system, the desalination system, and the like, as discussed herein, using a water stream 406 and an ammonia stream 405, 103. The chilled ammonia system includes multiple separators 412, 414, 416, and 418, and stripper units 420 and 422.

In the depicted embodiment, the exhaust gas stream 404 (e.g., an untreated flue gas) is provided to the first separator 412. Additionally, a water stream 406a is provided to the first separator 412. As shown in the depicted embodiment, the water stream 406a may be cooled using a refrigerant (e.g., ‘REF’) base chilling system 426. In general, the exhaust gas stream 404 is subsequently directed to the second separator 416, to the third separator 418, and to the fourth separator 414 to produce treated flue gas 417. The exhaust gas 404 (e.g., CO₂ gas) provided to the second separator 416 is combined with the ammonia stream 405 in the second separator 416 to produce a CO₂ rich ammonia solution 408. At least a portion of the CO₂ rich ammonia solution 408 may be recirculated back into the second separator 416 and chilled using a refrigerant base chilling system 426. In any case, the CO₂ rich ammonia solution 408 output by the second separator 416 and directed to the first stripper unit 420 where the CO₂ rich ammonia solution is stripped to remove the CO₂ from the CO₂ rich ammonia solution 408 to produce the CO₂ stream 402 and a CO₂ lean ammonia solution 410. The CO₂ lean ammonia solution 410 is directed back to the second separator 416 where it may be used to capture additional CO₂ from the exhaust gas stream 404. The CO₂ stream 402 may be compressed via the compressor 424 and sent to storage. Additionally or alternatively, the CO₂ stream 402 may be treated with irrigation water acidified with nitric acid, as discussed above, to scrub ammonia from the CO₂ stream 402.

A CO₂ rich ammonia tank and a CO₂ lean ammonia tank are provided so that CO₂ can be continuously captured, but only released (steam regenerated) during daylight hours when the greenhouse may utilize CO₂. The additional extracted steam from the CSP steam turbine causes a minimal loss of power (<2%), and would typically be compensated for with additional daytime PV that is generated during sunny high greenhouse CO₂ demand conditions.

It is also recognized that the disclosed techniques may enable integration of PV, wind power, full recovery desalination with intermediate brine storage and greenhouse climatization (year round temperature, humidity and CO₂ control), with solar based fertilizer generation (ammonium nitrate, potassium nitrate) may enable renewable energy and seawater to meet certain needs for desert cities (power, summer cooling, fresh water, food, basic raw materials/minerals). Further, at least in some instances, the infrastructure system has minimal hydrocarbon requirements and carbon dioxide generation (<5% of the hydrocarbon requirements and CO₂ generation versus conventional fossil fuel based production methods for the same energy, water, food and minerals products. Further still, by locating the CSP, PV, wind, greenhouse, and RO concentrate MVR concentrator at a remote higher elevation site may improve the performance of the power generation system, enables cost effective greenhouse evaporative cooling, while simultaneously providing a fresh water source to recharge the remote depleted fossil water underground aquifers, which are not subject to salt water intrusion.

In some embodiments, greenhouse is cooled using RO concentrate this provides the necessary cooling while simultaneously producing concentrated, high purity (not contaminated with dirt or dust) sodium chloride brine suitable for economic production of high purity (>99%) chemical grade salt. Other seawater greenhouse designs use seawater and unfiltered ambient air for cooling. This produces a dust contaminated concentrated seawater that may be disposed of back to the sea. It is noted that, using the greenhouse to evaporate the brine in the summer may eliminate a need to operate the RO concentrate MVR brine concentrators. This frees up significant power (˜40% of the total power may be utilized for full recovery desalination), during the summer months that can be used for building cooling. The CSP uses RO concentrate for once through steam generation (OTSG) to produce power, desalinated water and solids free and dust free concentrated brine suitable for economic production of high purity (>99%) chemical grade salt. Other CSP systems can produce byproduct desalinated water using extracted low pressure steam from the steam turbine and multi-effect distillation or evaporation. However, this significantly reduces baseload CSP power production since over 30% of the CSP power generation occurs in the steam turbine from 5 psig (34 KPa) (minimum extraction pressure) to the condensing pressure (2.5 to 3 psig, 17-20 KPa). In fact, the power loss from the CSP for thermal desalinated water production is higher than the power may be utilized for a high efficiency MVR to produce the same amount of desalinated water.

By using OTSG no power is lost since the CSP boiler is producing essentially the same amount of high pressure saturated steam as a closed loop system, except that all the steam condensate, including the extracted steam used for boiler preheating is cooled (preheating the boiler feedwater) and exported as desalinated water. The only costs to OTSG using RO concentrate is the upgrading of the boiler feed water heaters to titanium tubes/plates and the titanium cladding of the HP steam drum. The cost of this metallurgy upgrade to just the preheaters and steam drum is small (<5% of the total installed cost of the CSP system), making it much more economical than losing significant power production from steam turbine steam extraction for desalinated water.

While certain conventional systems may provide single effect efficiency. That is, for example, a large solar collection field may be utilized to collect the large amount of energy utilized for a single effect evaporator. Since the majority of the cost for a CSP plant is the solar collection system, the economics versus CSP using OTSG RO concentrate are highly unfavorable. Moreover, in such conventional systems, no power may be produced from the steam can be produced since the steam is non-pressurized

Water Processing System Integrated with Solar and Wind Power

In another embodiment, the disclosed embodiments include a water processing system (e.g., a desalination system) that is at least partially powered by renewable energy sources. Certain geographic regions may not have access to fresh water sources. As discussed herein, geographic regions with arid climates may utilize desalination plants to provide fresh water, building cooling for climate control and refrigeration to prevent food spoilage. It is desirable to use renewable non-CO₂ emitting power sources (wind and solar power) for these demands; however the low availability of the renewable power sources creates a reliability problem. Desalination plants, especially those with minerals recovery may operate for relatively long periods of time (e.g., greater than 4 hours, 8 hours, 12 hours, and/or 24 hours each day during a week) in order to maximize water and byproduct minerals revenue from the large fixed capital investment. In addition the associated commercial and residential power demand for building cooling and refrigeration in the community surrounding the desalination plant is highly variable and impacts power available for desalination. Power can be stored in batteries for electrical grid consumption; however battery storage may be cost effective up to a maximum amount of time (e.g., <4 hours) that may not be suitable for relatively long periods of time. Cloudy or low wind conditions may occur for several consecutive days even in arid and windy regions of the world.

Thus CO₂ emitting, non-renewable fossil fuels may be used to back up the wind and solar power generation or loss of desalinated water, building cooling or refrigeration could occur during exceptional weather conditions. It would be desirable to minimize CO₂ emitting, non-renewable fossil fuels, maximize the use of renewable power and have highly reliable desalinated water, building cooling and refrigeration.

### Desalination Plant

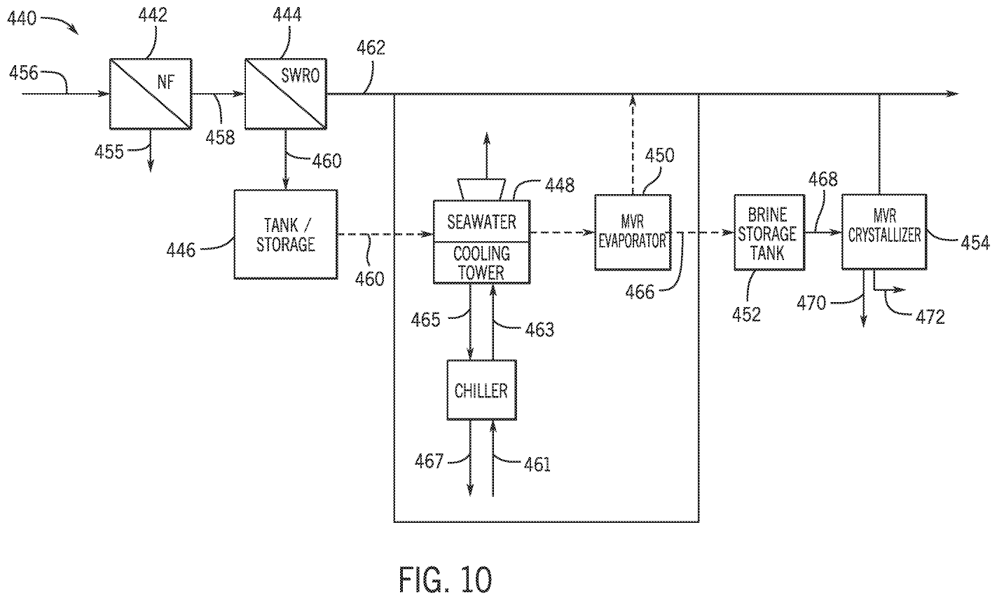

FIG. 10 is a block diagram of an example of a water processing system 440 (e.g., desalination plant), in accordance with the present techniques. The desalination plant comprises an intake and pretreatment system (not shown) where seawater is screened, filtered and optionally treated with dissolved air flotation (fine solids removal) and biologically active carbon filter (organics removal). The essentially solids and organics free seawater containing approximately 4 wt % dissolved solids is pumped to a relatively lower pressure e.g., (<200 psig, 14 bar)) nanofiltration (NF) membrane system to produce calcium, magnesium and sulfate rich brine for calcium, magnesium and sulfate recovery or disposal and NF permeate.

In the depicted embodiment, the water processing system 440 includes a nanofiltration unit 442, an SWRO unit 444, a brine storage tank 446, a cooling system 448, an MVR evaporator 450, a brine storage tank 452 (e.g. 25% brine), and an MVR crystallizer 454. Pretreated water 456 (e.g. including 4% dissolved solids, 290 MGD) is directed to the NF unit 442 to produce a brine stream 455 (e.g. a calcium, magnesium, sulfate rich brine for disposal or for minerals and water recovery) and a permeate stream 458. The SWRO 444 receives the permeate stream 458 and generates a desalinated water stream 462 and a second brine stream 460. The brine storage tank 446 (e.g., including 8% brine) receives and/or stores the second brine stream 460 for further use. For example, the cooling system 448 may receive the second brine stream 460 and provide district cooling to components of the water processing system as discussed herein (e.g., streams 461 and 463 may be cooled or heated to produce streams 465 and 467).

The NF permeate containing mainly sodium chloride and water is pumped to high pressure (>1000 psig, >69 bar) seawater reverse osmosis (SWRO) membranes to produce 7-8 wt % sodium chloride rich brine and desalinated water. The 7-8 wt % sodium chloride brine is stored in a tank or pond. This may allow the low power consuming, startup/shutdown sensitive pretreatment, NF and SWRO membrane sections to operate continuously and may allow the high power consuming startup/shutdown insensitive 7-8 w % sodium chloride brine evaporation system to operate during daylight when solar power is generally available.

During daytime when solar power is available the 7-8 wt % sodium chloride brine is pumped from storage to a seawater cooling tower which provides cooling water for a high efficiency chiller system that produces chilled water or ice for a thermal energy storage system (stratified water tanks or ice storage tanks—not shown). The chiller's high efficiency results from using the seawater cooling tower instead of air cooling which can typically produce cold water >30 F below the daytime ambient temperature in arid climate. It is noted that the lower temperature cooling water has a significant impact on chiller efficiency. The 7-8 wt % sodium chloride brine is concentrated to approximately 10 wt % in the cooling tower due to evaporation of part of the water.

The 10 wt % brine is filtered (not shown) to remove any dust particles that entered the cooling water from the seawater cooling tower and is routed to a mechanical vapor recompression (MVR) brine evaporator. The brine evaporator uses significant power to concentrate the 10 wt % brine to 25 wt % (near saturation) and produce desalinated water. The 25 wt % brine is routed to a 25 wt % brine tank or pond. This may allow the power intensive chillers and brine evaporators to operate during daytime when solar power is available.

The 25 wt % brine is pumped from storage to a capital intensive MVR salt crystallizer which is operated continuously to produce NaCl salt and desalinated water. This maximizes the utilization of this capital intensive plant section. An optional small purge (<5% of the crystallizer feed) is sent to disposal or further minerals recovery (KCl, bromine etc) to maintain NaCl product salt purity.

### Power Generation

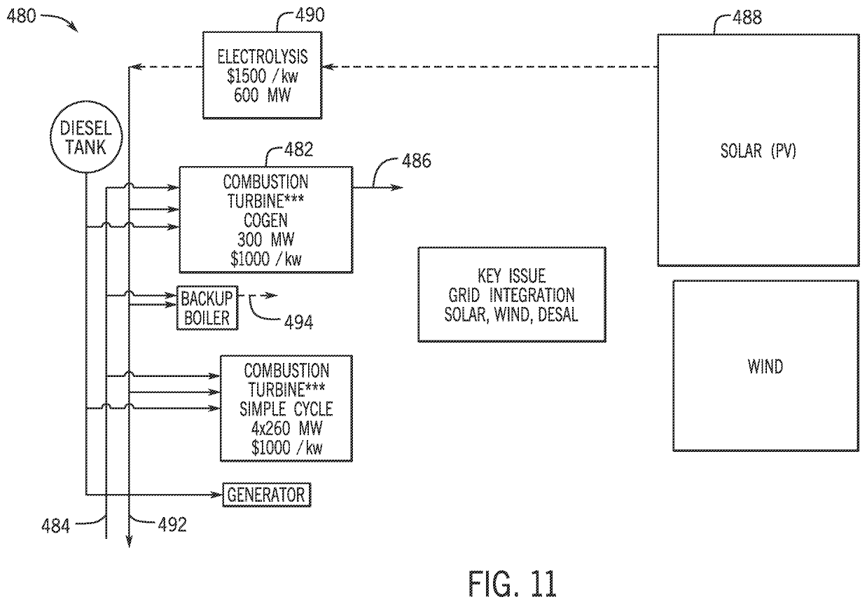

FIG. 11 shows a block diagram of an example of a power generation system, which may be incorporated with the water processing system discussed herein. The power generation system includes renewable power sources (e.g., wind and solar) and hybrid renewable/fossil fuel power sources (e.g., natural gas and hydrogen fueled). These two systems may be coordinated with a dispatch model to maximize renewable power generation capacity and utilization and minimize fossil fuel power. For example, fossil fuel generation may be utilized for high efficiency (>80% energy recovery) cogen (e.g., steam and power generation) and backup power.

In the depicted embodiment, the combustion turbine 482 receives a natural gas supply 484 and produces steam 486. Additionally, the solar panel 488 powers the electrolysis system 490 (e.g., the electrolysis unit 172) to produce hydrogen 492 (e.g., the hydrogen stream 174) and steam 494. It should be noted that the dollar amounts are merely examples.

### Renewable Power

The majority of the power production (>70%) and installed capacity (>60%) is wind and solar power. For arid locations where desalination plants are utilized, solar power is typically cheaper ($/kw) and has a higher availability than wind power. Thus it typically has a higher installed capacity than wind power for locations that also may utilize desalinated water.

During winter conditions arid regions typically have low power demand. During this time excess solar and wind power are used to generate hydrogen (and potentially oxygen) from desalinated water using electrolysis. This may allow the renewable power capacity to be maximized (i.e., designed to serve the maximum summer power demand). During the winter the excess generating capacity is used to generate hydrogen, avoiding idling renewable generation when there is insufficient electrical load.

The hydrogen and potentially oxygen are exported to pipelines or used to fuel the cogen turbine. During periods of high power demand and low renewable power production, the hydrogen flow is reversed and hydrogen from the pipeline system is used as a fuel gas component in the backup/peaker turbines.

The hydrogen pipeline system may include steam methane reformers (SMR's) that are swing producers of hydrogen from natural gas. During periods of low hydrogen demand the natural gas that would have fed the SMR's is either stored in underground storage or is shut in at the well head and not produced. Thus, seasonal underground natural gas storage may be used to provide the large volumes of stored fuel gas energy (hydrogen and natural gas) utilized to provide backup power when renewable energy is not available. This avoids expensive battery storage that cannot economically provide backup power for worst case extended periods (up to 14 days) of cloudiness or low wind when renewable power is not available or is available at reduced capacity.

Optionally CO₂ may be captured and sequestered underground for enhanced oil recovery or long term storage from the SMR's that produce the swing hydrogen. In addition excess hydrogen from electrolysis could be injected into the underground gas storage system to reduce the requirement for SMR swing hydrogen production and its associated CO₂ emissions.

### Fossil Fueled Power

In some embodiments, fossil fueled power generation system may include a cogen turbine(s) operating continuously to produce the steam and some of the power utilized by the desalination plant; a simple cycle, low cost ($/kw) backup combustion turbines with a capacity of approximately 50% of the renewable power capacity; a backup steam boiler for cogen turbine outages. In some embodiments, the fossil-fueled power generation system may be fueled by a mixture of 70% (by low heating value) natural gas and 30% (by low heating value) fuel gas. This minimizes CO₂ emissions while still allowing conventional natural gas turbines and boilers to be used.

Backup emergency diesel may also be used in the above power generating systems to ensure that fuel is always available to the fossil fueled power generation system. Small (<1% of total system power generating capacity) emergency diesel generators are used to provide emergency power and black start power (turbine restart power) during power grid or pipeline outages and power generation system restart.

### Thermal Energy Storage

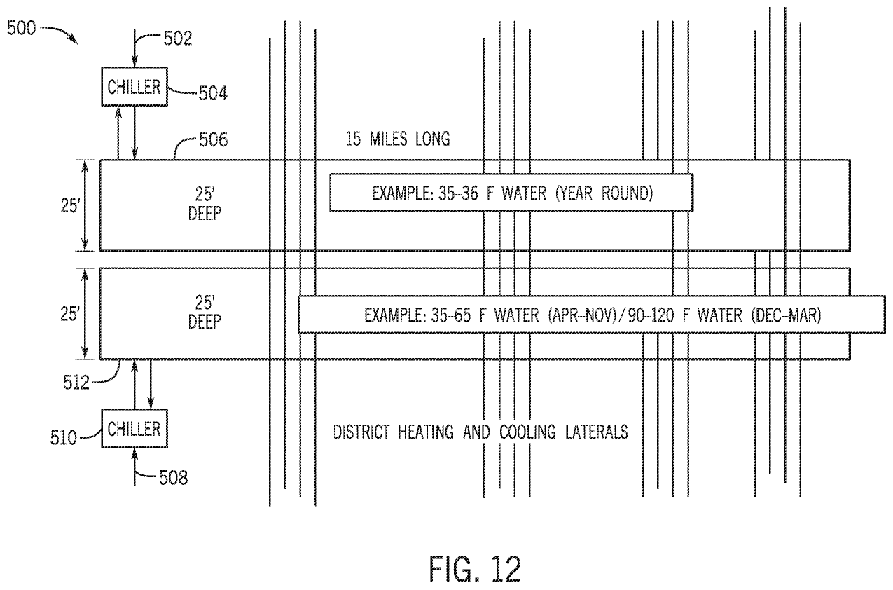

FIG. 12 shows a block diagram of an underground liquid storage system 500 (e.g., or at least partially underground), which may be incorporated with the water processing system discussed herein. Low cost thermal energy storage (TES) may be used instead of expensive batteries to provide intermediate term (1-3 days) electrical production and consumption balancing. Underground chilled or heated water storage may be used to store energy for heating and cooling. Chilled and heated water is supplied to residential and commercial users so that essentially no uncontrolled (user controlled) local heating and cooling power is used.

In the depicted embodiment, a first supply of solar power 502 (e.g., 1 GW for 12 hours per day) may be provided to the chiller 504 to cool the top liquid storage 506. Additionally, a second supply of solar power 508 (e.g., 500 MW for 4 to 8 hours per day) may be provided to the chiller 510 to cool the bottom liquid storage 512.

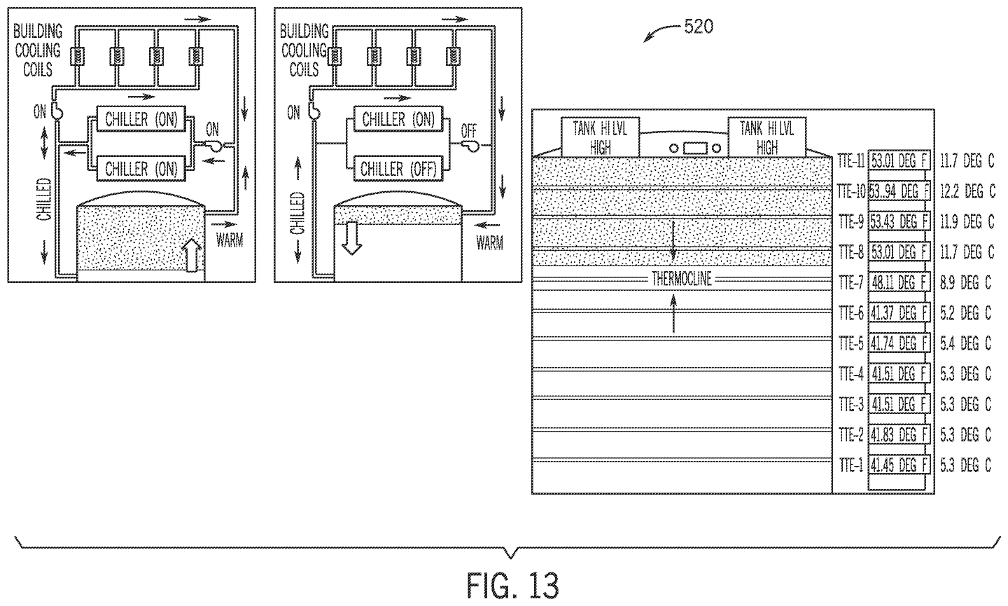

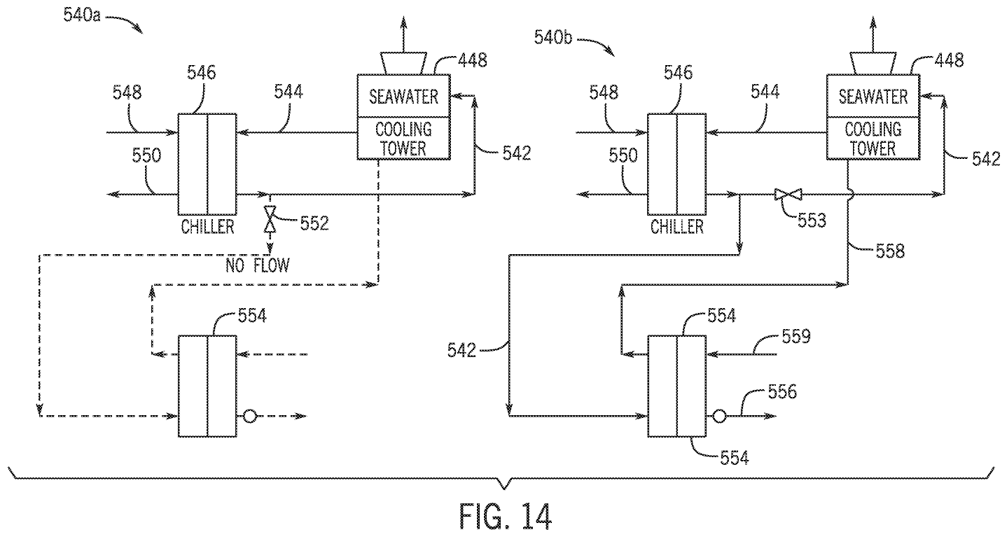

Individual heating and cooling demands may be achieved by using variable flows of hot and cold water from the common district storage tank(s) which are stratified storage tanks 520, an example of which is shown in FIG. 13. Warmer water is stored on top of colder water in the tanks to maintain the correct feed water temperature to the users. During the summer when renewable power is available the warm chilled water is re-chilled (using an electrically powered chiller with a seawater cooling tower—see desalination above). During the winter when renewable power is available (daytime) the warm chilled water is re-chilled (using an electrically powered chiller with the warm water routed to a heat pump). The cold warm water is re-heated using an electrically powered hybrid heat pump with the cold water routed to the warm side of the chiller. The electrical resistance heater in the hybrid heat pump may make up any shortfall in heat provided by the chiller and the seawater cooling tower makes up any shortfall in heat removed by the heat pump. An example of the electrical resistance heater incorporated in the underground liquid storage system is shown in FIG. 14. The thermal energy storage system may allow the re-chilling and reheating to occur when renewable power is available.

In general, the block diagram 540a illustrates operation of the cooling system 448 during relatively warmer periods of time (e.g., during the summer or spring) and the block diagram 540b illustrates operation of the cooling system 448 during relatively cooler periods of time (e.g., during the winter or fall). For example, as shown in the block diagram 540a, the cooling system 448 receives a first fluid flow 542 (e.g., 85 F, 29° C.) and outputs a second fluid flow 544 (e.g., 75F, 24° C.). The chiller 546 generally receives the second fluid flow 544 and a third fluid flow 548 (e.g., 65 F, 18° C.), and outputs a fifth fluid flow 550 (e.g., 35 F, 2° C.) and the first fluid flow. In this example, the valve 552 is closed, and there is no flow to the heat pump 554 (e.g., hybrid heat pump). In the block diagram 540b, the valve 553 may be partially opened, such that the first fluid flow 542 (e.g., 70 F, 20° C.) is provided to the cooling system 448 and the heat pump 554. The heat pump 554 outputs a sixth fluid flow 556 (e.g., 120 F, 50° C.) and a seventh fluid flow 558 (e.g., 50 F, 10° C.), and receives an eighth fluid flow 559 (e.g., 90F, 30° C.).

In addition to providing building cooling the chilled water (35 F, 2° C.) may also be used for refrigeration and freezing instead of higher temperature (>80 F, 25° C.) air cooling. The chilled water is used in the refrigerant condenser which significantly reduces (>60%) the local power consumption for refrigeration and freezing. The majority of the cooling is provided by the chilled water system which uses thermal energy storage and renewable power. The water cooled refrigeration and freezing systems also use significantly less refrigerant which lowers cost and global warming potential from refrigerant leakage. This also may allow essentially all of the heat removed from the refrigeration and freezer systems to be used by the heating system in the winter.

### Dispatch Model

In order for the three components (desalination plant, power plant, thermal energy storage) to properly work well together a dispatch model is used. This is typically a computer model which decides which load components (desalination brine concentrators, chillers, water heaters, electrolysis) and which power generators are operated. Weather forecasting is included so that the thermal energy storage system, brine storage systems and electrolysis is optimally utilized (i.e., storage filled before forecast loss of renewable power). Since the majority of the power demand for desalination, heating, cooling, and refrigeration is centrally controlled, the majority of the electrical load can be adjusted to match the availability of renewable power with minimum backup fossil fuel power.

Time of day power metering (i.e., and pricing), peak demand metering (i.e., and charges), and differentiated firm and interruptible power (i.e., and pricing) may be used to provide power pricing incentives so that the power demand for the remaining user controlled devices (electric vehicles, ovens, driers, washer, hot water heater, battery chargers, industrial equipment, etc.) more closely matches the availability of renewable power. This minimizes or eliminates utilizing short term (e.g., less than 4 hours) stationary peak shaving batteries. Essentially all of the batteries may be used to eliminate mobile CO₂ emission sources and would be recharged when renewable power was available.

### Technical Effects

Excess winter solar power is used in water electrolysis to produce hydrogen and optionally oxygen to use in pipeline systems. Natural gas fueled, steam methane reformer (SMR) based hydrogen production is turned down during hydrogen export from electrolysis allowing reduced natural gas production or filling of underground natural gas storage.

Hydrogen from electrolysis or the hydrogen pipeline (e.g., natural gas fueled SMR or coke fueled gasification equipped with CO₂ capture and sequestration for enhanced oil recovery—EOR) is blended with natural gas to fuel high efficiency (e.g., >80% energy recovery) steam and power generating plants (e.g., cogen plants). Typically conventional combustion turbines can operate using up to 30% of the utilized fuel energy as hydrogen reducing CO₂ emissions by 30%. This provides low CO₂ baseload power and steam. It also provides low CO₂ backup power to be generated from conventional natural gas turbines which may allow uninterrupted desalination plant operation during periods of low wind and solar generation and high residential and commercial demand.

A chilled water system using a once through seawater cooling tower fed by RO concentrate is used to provide chilled water to a thermal energy storage based district cooling system using renewable power. Renewable power is used in an electric powered hot water heater (heat pump or resistance heater) to provide hot water in the winter to a portion of the thermal energy storage system to support building heating. This cost effectively stores equivalent electricity in the form of refrigerated or heated water versus batteries. This stored equivalent electrical energy may allow additional wind and solar power production capacity since the excess capacity on good weather days can be stored and used for poor weather days. This also reduces backup power demand when the power demand for cooling or heating is greater than power production from wind and solar.

The seawater cooling tower utilized by the water chiller eliminates the cost and power demand for some of the electrically powered brine concentrators utilized for minerals recovery. Integrating the cooling tower into the minerals recovery desalination plant also eliminates the cooling tower discharge stream which typically contains biocides and has an elevated salinity due to evaporation in the cooling tower. The SWRO concentrate is nearly sterile due to the extensive pretreatment utilized to protect the RO membranes. Bleach (biocide) and hydrochloric acid (acidification to prevent mollusk growth) can be added to the cooling tower, which may block, prevent, reduce, or substantially eliminate biofouling since the once through cooling tower effluent is routed to minerals recovery and not discharged.

The desalination plant uses an oversized brine concentration mechanical vapor recompression (MVR) evaporator section with feed and product brine storage so that the high power demand brine concentrators can be operated to match the availability of wind and solar power. They would typically operate during daylight hours to match solar power production. This maximizes solar power production and consumption and minimizes gas fired backup power requirements. The brine storage and excess brine concentrator capacity also increases desalination plant availability by providing emergency brine storage and catch up brine concentrator capacity.

The reliable flow of stored chilled water is used to provide reliable high efficiency building cooling and as a heat sink for commercial and residential refrigerators and freezers. This may allow >90% of the power utilized for building cooling, refrigerators and freezers to be supplied by wind and solar power. In addition in the winter it may allow the majority of the heat removed from the refrigerators and freezers to be used for building heating.

With all the above novel features and benefits >75% of the total annual electrical energy utilized for the desalination plant and associated commercial and residential power loads can be cost effectively supplied by wind and solar power. The CO₂ emissions for the natural gas+hydrogen fueled cogen and backup power generation are reduced to <15% of what would have been otherwise emitted from a conventional natural gas fueled combustion turbine based plant with air cooled building and refrigeration systems. This is due to the 70% wind and solar power generation, the natural gas+hydrogen fuel and the increased cooling and cogen efficiencies.

Additionally or alternatively, the disclosed embodiments may include a water processing system (e.g., a desalination system) that may generate certain chemicals for crop fertilization and nutrition. In general, geographic regions with arid climates may utilize water processing systems to provide fresh water for potable water systems and for agriculture. At least in some instances, agricultural consumption of water is much higher than potable water use and it is not always economical to provide desalinated water for agriculture. While low cost photovoltaic (PV) power may be available in these arid regions, the PV power may not integrate well with water processing systems. Certain water processing systems, such as water processing systems with minerals recovery may operate for a relatively long portion of the day (e.g., approximately 12 hours, 18 hours, 24 hours) at a relatively high capacity (e.g., greater than 80%, approximately 100%) of design in order to enhance (e.g., maximize) water and byproduct minerals revenue from the large fixed capital investment. In addition, a significant portion of the energy utilized for full recovery desalination may be utilized to further concentrate the seawater reverse osmosis (SWRO) concentrate (8-10 wt % NaCl) to a nearly saturated brine (25 wt %) suitable for purified NaCl crystallizer conversion to high purity (>99.9% NaCl) industrial salt.

Seawater greenhouses using seawater or SWRO concentrate are commercially available to provide greenhouse evaporative cooling. Seawater greenhouses save 80-90% of the fresh water that may utilized by a greenhouse in a hot arid climate that uses fresh water evaporative cooling. However, certain existing seawater greenhouses may use a recirculating pad and fan system (e.g., a wet wall of the greenhouse with a forced air flow), and are not designed to produce a high purity (i.e., no dust contamination), high concentration (e.g., greater than approximately 25 wt % NaCl) brine for high purity NaCl recovery. In addition, greenhouse and agricultural water demand may be seasonal, and thus may not always match desalinated water production from a baseloaded (24/7/365 operation) minerals recovery water processing system operating at 100% capacity. Tanks can be used to store excess desalinated water but these may not be economical for large volumes utilized to buffer seasonal demand.

Agricultural seaweed production consumes almost no fresh water, and thus may be a desirable agricultural product in arid regions. However, in arid regions, seaweed production may consume valuable coastline in environmentally sensitive areas (i.e., coral reefs) for partially submerged rope based systems. In addition, these systems may be subject to predators and parasites (e.g., sea turtles, viruses, algae), and utilize labor intensive harvesting (e.g., boats or wading). While certain land based systems are available, these land based systems may utilize a nutrient rich feed seawater intake and produce an effluent seawater to purge dust, organic seaweed impurities and other dissolved impurities from the land based system. This may be undesirable in environmentally sensitive tropical reef areas. The land based systems are based on fluidized bed agitation (seaweed and water moving together) which may not accurately simulate optimum seaweed growth conditions (fixed seaweed and wave and current seawater movement) for some high value seaweeds.

Power can be stored in batteries for electrical grid consumption; however, battery storage is may not be cost effective for relatively long time periods (e.g., greater than approximately 4 hours). Cloudy or low wind conditions may occur for several consecutive days even in arid and windy regions of the world. CO₂ emitting, non-renewable fossil fuels can be used to back up the power generation, but it is desirable to use this backup power for exceptional long term cloudy conditions and not on a daily basis.

Thus, it is presently recognized that it would desirable to have a water processing system where at least a portion of normal power is provided by daytime PV power. Another portion of the power (e.g., <10%) (MWh basis) may be provided by backup fossil fuel based generation. In some embodiments, the water processing system may include seawater greenhouse design that simultaneously converts SWRO concentrate to high purity 25 wt % NaCl brine and provides greenhouse air cooling to reduce the greenhouse fresh water consumption by 80-90%. In some embodiments, the water processing system may include a protected agriculture system (that uses the humidified, cooled seawater greenhouse effluent to significantly decrease fresh water agricultural demand for lower value field crops that cannot be economically grown in a greenhouse (e.g., citrus fruits, alfalfa, red clover, soybeans). In some embodiments, the water processing system includes dairy and poultry barns (e.g., a livestock system) that can be cooled using SWRO concentrate (producing 25 wt % NaCl brine) and can provide organic fertilizer for the greenhouse and protected agriculture crops. In some embodiments, the water processing system includes a solar power based CO₂ recovery system (e.g., a greenhouse recovery system) that captures CO₂ from the full recovery water processing system and releases the CO₂ to the greenhouse and protected agriculture system to enhance (e.g., maximize) crop yield per gallon or m3 of fresh or desalination irrigation water. In some embodiments, the water processing system includes a concentrated solar power (CSP) based system (e.g., a solar energy system) that uses SWRO concentrate (instead of recirculated steam condensate) to produce power, steam condensate (desalinated water) and SWRO brine (25 wt % NaCl) in a once through configuration. In some embodiments, the water processing system includes an underground aquifer storage and recovery system that is configured to store product desalinated water for seasonal storage. Water is pumped from the storage during daytime using low cost PV power and released to the storage during nighttime allowing nighttime power production. Further, in some embodiments, the water processing system includes a land based seaweed production system that uses a feed stream from the water processing system, produces an effluent stream that is routed back to the water processing system, uses a fixed seaweed and moving water system to accurately mimic optimal or natural seaweed growth environment, and/or includes an automated (e.g., or semi-automated) land based harvesting system.

### PV Power to Water Processing System

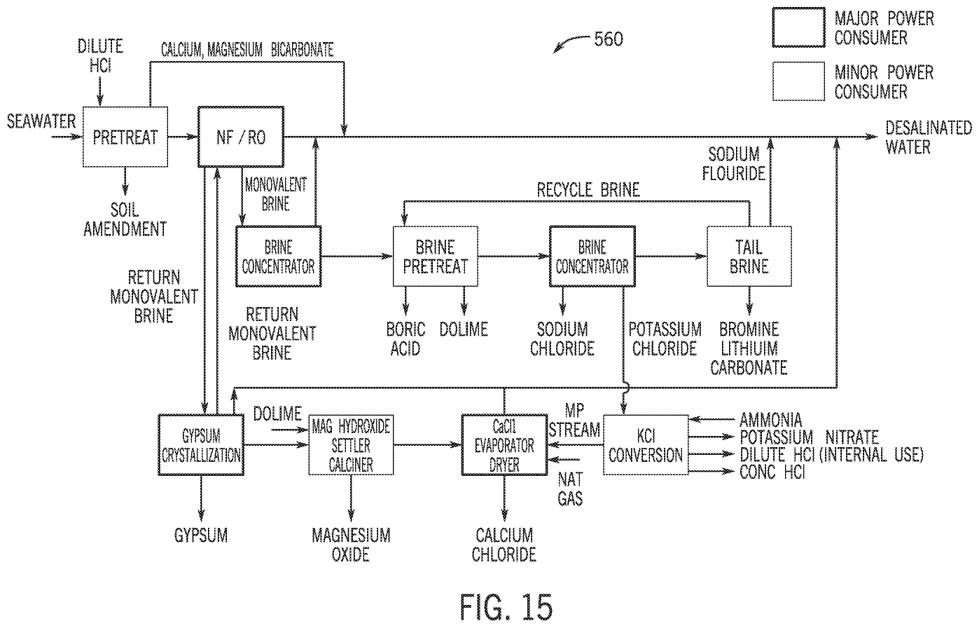

FIG. 15 shows a block diagram of a water processing system 560, in accordance with aspects of the present disclosure. The water processing system consists of multiple separation and mineral recovery steps (e.g., indicated as the arrows between the blocks), which may utilize significant electrical power. At least some of these steps, such as the production of calcium and/or magnesium bicarbonate based on the pretreatment system (e.g., pretreat), the production of gypsum by the gypsum crystallization system, the production of sodium chloride by the brine concentrator and crystallizer, and the production of potassium chloride by the brine crystallization may consume a signification amount of power (e.g., greater than 90% of the power used by the water processing system), and thus it would be desirable to use low cost ($0.010-$0.015/kwh) PV power as their power source. However, at least in some instances, PV power may be available during daylight hours and batteries to store the PV power are uneconomical.

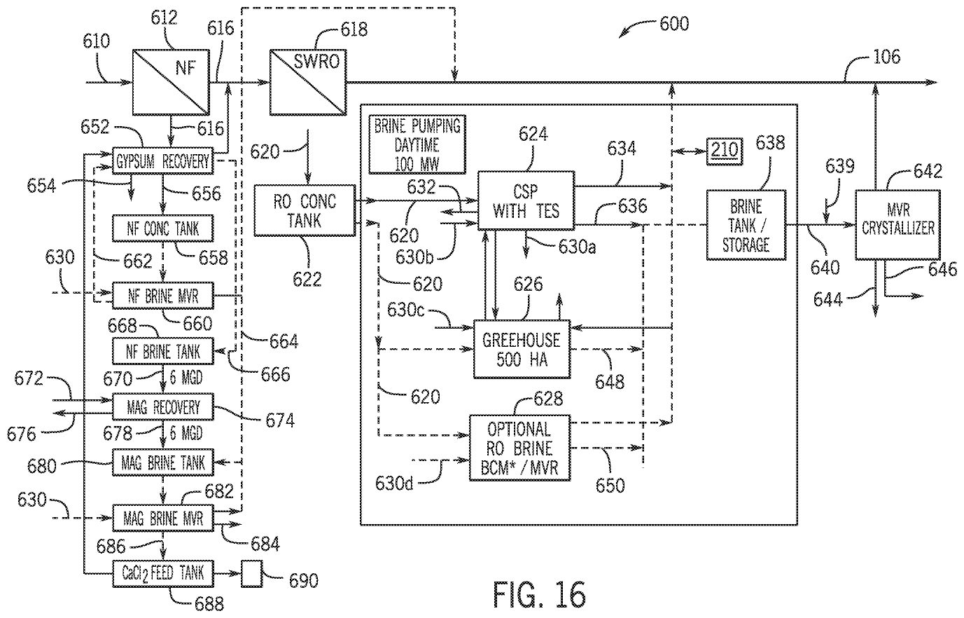

FIG. 16 shows a block diagram of the water processing system of FIG. 15 with additional features. The divalent brine (e.g., gypsum) mechanical vapor recompression (MVR) evaporator (e.g., NF Brine MVF) may have a relatively low flow and can use feed and product tankage (e.g., NF Conc Tank) and excess MVR capacity to allow MVR operation when PV power is available. This may increase capital cost, but the reliability increase and power cost savings makes this solution economically viable.

In the depicted embodiment of the water processing system 600 (e.g., desalination system), a pretreated seawater stream 610 (e.g., including 4% dissolved solids, 290 MGD, 1.1 MCMD) is provided to a nanofiltration (NF) system 612. The NF system 612 outputs a first brine stream 614 (e.g., NF permeate stream) and a first mineral slurry 616 (e.g., NF concentrate stream).

The SWRO unit 618 receives the first brine stream 614 and outputs desalinated water 106 and an SWRO concentrate stream 620 (e.g., RO concentrate). The SWRO concentrate stream 620 may be stored in a tank 622 (e.g., 8% RO Concentrate tank) and/or directed to a CSP with TES 624, a greenhouse system 626, an RO Brine Conversion Membrane/MVR unit 628, or a combination thereof. Power 630 produced by the CSP 624 may be provided to one or more units discussed herein. In general, the CSP 624 may produce a first amount of power 630a (e.g., 25 MW at night, 15 MW during the day) and receive power 630b (e.g., 10 MW). The CSP 624 may output a low pressure steam or CO₂ stream 632, a second brine stream 634 (e.g., 0.8 MGD), and a third brine stream 636 (e.g., 0.2 MGD). The second brine stream 634 may be directed to the desalinated water 106 to remineralize the water, and the third brine stream 636 may be stored in a brine storage tank 638. Additional minerals 639 (e.g., recycle salts from a Mag MVR, such as KCl/Bromine recovery) may be added to a brine stream 640 provided by the brine storage tank 638, and the brine stream 640 may be directed to a softener and salt MVR crystallizer 642. The MVR crystallizer 642 may produce salt 644 and a purge stream 646 that may be directed to a KCl recovery and/or bromine recovery system. The second brine stream 634 may be combined with a fourth brine stream 648 output by the greenhouse system 626 and/or a fifth brine stream 650 output by the RO brine BCM/MVR 628 to produce a sixth brine stream (e.g., 0 MGD during the summer, 66 MGD during the winter) that is added to the desalinated water 106 and/or directed to the aquifer storage and recovery system 210 (ASR).

The first mineral slurry 616 is directed to a gypsum recovery system 652 that produces gypsum 654 and a second NF concentrate stream 656 (e.g., 45 MGD) that may be stored in an NF concentrate tank 658 and/or directed to an NF brine MVR 660. The NF brine MVR 660 outputs gypsum seed 662 and a first NF concentrate brine stream 664.

A second NF concentrate brine stream 666 output by the gypsum recovery system 652 is output to an NF brine tank 668. The first NF brine stream 670 (e.g., 6 MGD) from the NF brine tank 668 and dolime 672 are directed to a magnesium recovery system 674, which outputs magnesium hydroxide 676 and a second NF brine stream 678. The second NF brine stream 678 is directed to a magnesium brine tank 680 and/or a magnesium brine MVR 682 that outputs a recycle salt 684 and an MVR brine stream 686. The MVR brine stream 686 is directed to a CaCl2 feed tank 688, and may be subsequently be directed to a CaCl2 recovery system 690.

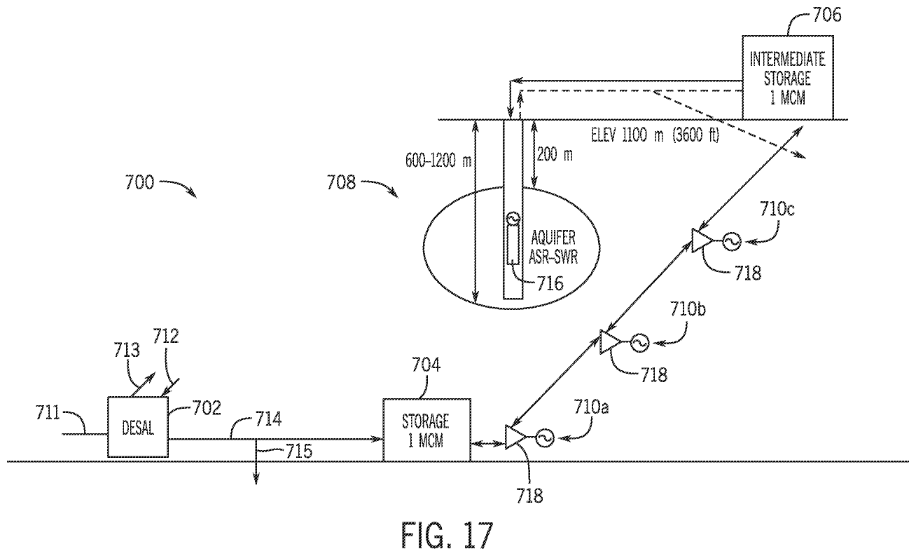

The nanofiltration (NF) and seawater reverse osmosis (SWRO) membranes and the brine crystallizer use large volumes of water and may be operate continuously to prevent scaling or plugging in the systems. For these units, PV power and a pumped storage system is used. During daytime product desalinated water is pumped to an elevated storage tank using PV power and the NF and SWRO membranes and the MVR brine crystallizer (e.g., the brine crystallizer shown in FIG. 15) may be operated using PV power. During night operation, the product water may be released from the elevated storage tank and the pumps are used as generators, as shown in FIG. 17. In the arid Red Sea, Gulf of Aden, eastern Mediterranean and eastern Arabian Gulf regions there are multiple locations where there is an elevated (1000-3500 feet) plateau above the ocean, making the pumped storage system feasible. In addition, as described below some of the product water will be pumped to seawater greenhouses located on the plateau. Thus, the pumped storage system is essentially an enlarged section of the product water pipeline.

The depicted embodiment of the water processing system 700 of FIG. 17 includes a desalination system 702, a first storage 704, a second storage 706, an aquifer unit 708, and one or more pump/turbine generators 710.

The desalination system 702 may receive a stream 711 (e.g., 0.8 MCMD) from the ASR, receive a brine stream 712 from the greenhouse, and output an SWRO concentrate stream 713 to the greenhouse. The desalination system 702 may output a second stream 714 to the first storage 704 having a relatively lower concentration of salts than the stream 711 (e.g., 0.63 MCMD), and the concentration of the stream 714 may vary based on the weather (e.g. 0.3 MCMD during the winter, and 0.2 MCMD during the summer). Additionally a stream 715 may be output to an agricultural system.

In general, the generators 710 may provide a variable power to pump the brine (e.g., 1 MCM) stored in the first storage 704 to the second storage 706 based on the season, time of day, weather, and the like. For example, the generator 710a may provide a pump 718 nighttime only-NF/RO power of 2.5 kwh/m3 output. In addition, the pump 718b may provide 100,000 m3/h supply (winter), 90,000 m3/h supply (summer), 70,000 m3/h return (1 m/s, 1 m/km DP), and 175 MW night power (e.g., provided by the generator 710).

The depicted embodiment also includes a submersible pump/turbine generator 716 that may also provide a variable power to a pump 718, such as 0.6 kWh/m3 input, 0.5 kWh/m3 output, 10 MW night power.

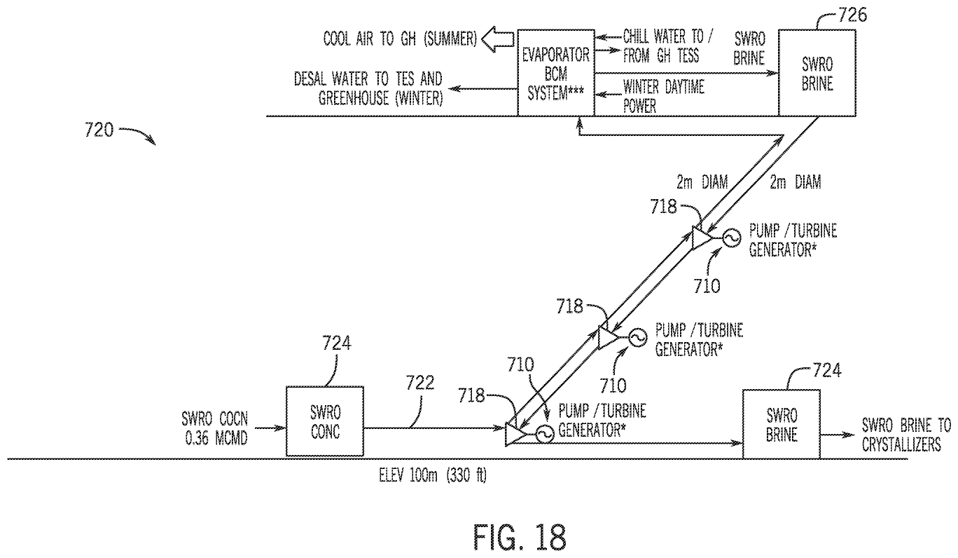

The brine concentrator section using either high cost MVR evaporators (commercial equipment) or lower cost brine concentration membranes (successfully piloted, no commercial experience) may be the largest power consumer in the water processing system and produces desalinated water as a marketable product. The saturated brine is utilized as feed for NaCl, KCl and other valuable monovalent minerals recovery. A significantly more economical solution may be to use the hot dry air located on the elevated plateau to evaporate the water from the monovalent brine to produce the saturated brine in a seawater greenhouse. Similar to the product water, the monovalent brine is pumped to the elevated greenhouse on the plateau during the daytime using PV power. During nighttime the concentrated, nearly saturated brine is released producing night power to provide a portion of the power to operate the NF and SWRO membranes and MVR brine crystallizer as shown in the embodiment of the water processing system 720 of FIG. 18.

In the depicted embodiment, the SWRO concentrate stream 722 from the tank 724 is transferred to an elevated brine storage tank 726 by the pumps 710. At least in some instances, the daytime pumping may utilize 3.1 kWh/m3 input and night time pumping may utilize 2.8 kWh/m3. SWRO brine from the tank 726

### Seawater Greenhouse

A significant portion (30-40%) of the water in the feed seawater may be vaporized in the seawater greenhouse. Certain existing seawater greenhouses may use seawater or SWRO concentrate to moisturize and cool the air fed to the greenhouse. However, pad and fan systems may be used with recirculated brine to cool and humidify the inlet air. These pads can foul and may be replaced in 1-4 years to maintain use in the high dust arid service experienced in the Middle East North Africa (MENA) region. A purge brine containing dust solids and dissolved dust components (e.g., silica, limestone, and the like) maybe be routed back to the ocean as a wastewater stream. Thus, a significantly different seawater evaporation system is utilized for the desalination application with the features provided below. At least in some instances, the evaporation system is operated during daytime hours when greenhouse solar heating occurs. This avoid excess humidity and fungus inducing condensation forming at night in the greenhouse.

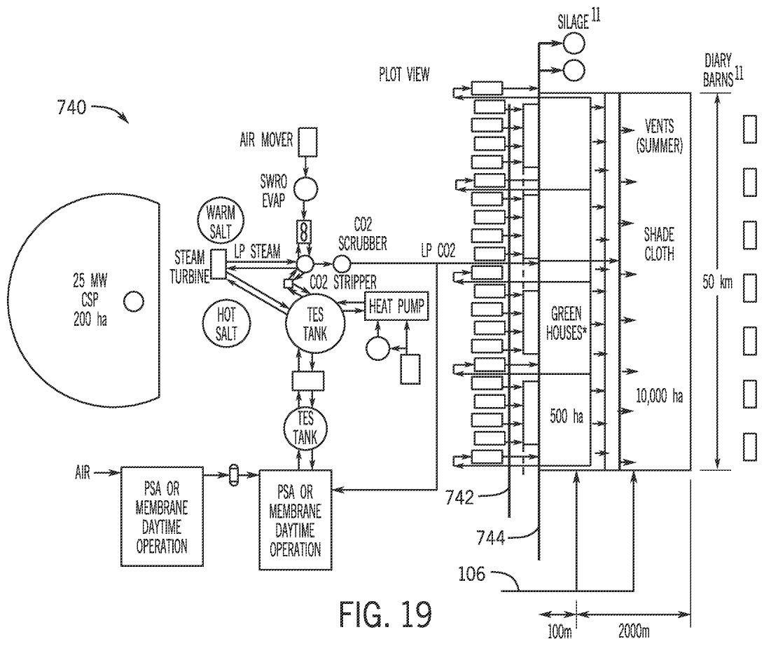

As an example of FIG. 19 is schematic diagram of an aerial view of a greenhouse recovery system 740 that may be incorporated into the water storage system of FIG. 15, in accordance with the present techniques.

The greenhouse recovery system 740 of FIG. 19 generally receives an SWRO concentrate stream 742 (e.g., 8-10 wt %, 0.4 MCMD), an NaCl brine stream 744 (e.g., 20-25 wt %, 0.1 MCMD), and desalinated water 106.

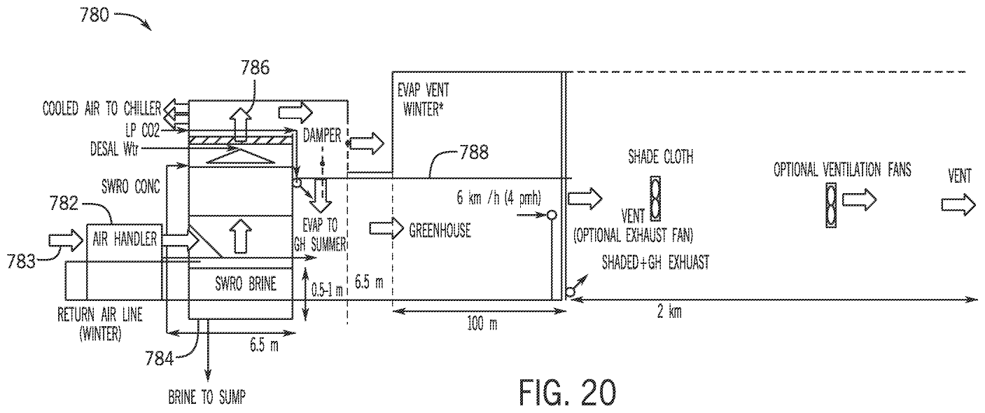

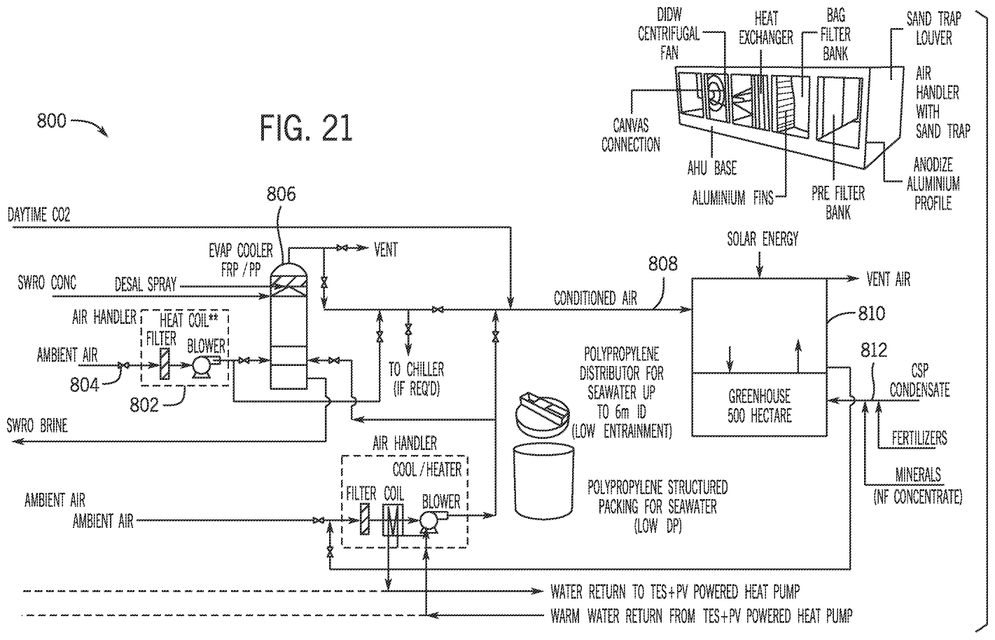

Additional features of the greenhouse recovery system are shown in FIGS. 20 and 21 and discussed in more detail below. For example, FIG. 20 is a schematic elevation view of a portion of the greenhouse recovery system of FIG. 19, in accordance with the present techniques.

The depicted embodiment of the greenhouse recovery system 780 of FIG. 20 includes an air handler 782 that directs an air flow 783 over an SWRO brine pool 784, which produces chilled air 786. The chilled air 786 may be used to cool the air in the greenhouse 788.

As another example, FIG. 21 is a schematic diagram of a portion of the greenhouse recovery system of FIG. 19 that includes a water processing system, in accordance with the present techniques.

In the depicted embodiment, an air handler 802 directs ambient air 804 into an evaporative cooler 806 that outputs conditioned air 808 to the greenhouse 810. In the depicted embodiment, the greenhouse receives a flow of CSP condensate 812.

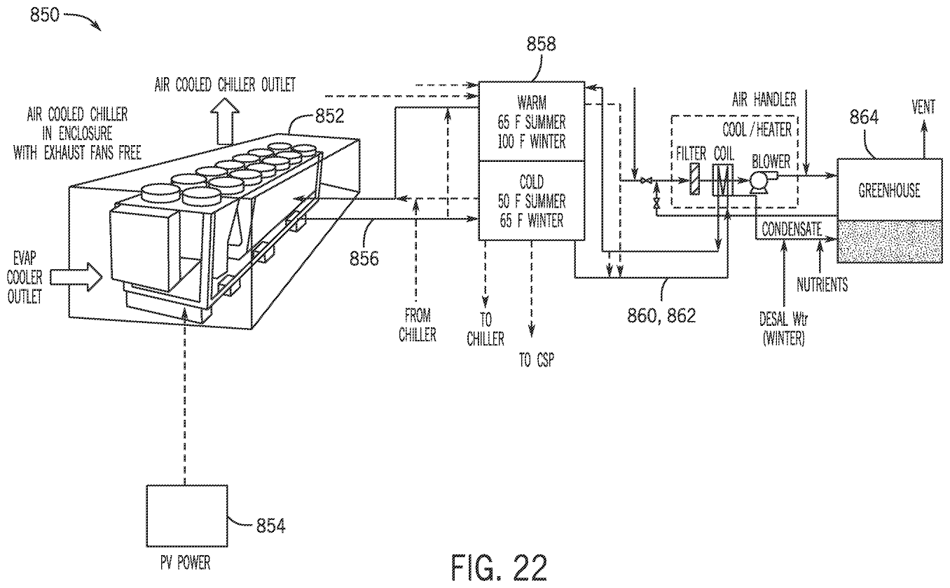

A commercial scale air handlers, as depicted in FIG. 22, such as air handlers utilized in warehouses, manufacturing facilities, and the like, may be used to provide a flow of filtered and essentially solids free ambient temperature and dewpoint air.

In the depicted embodiment, and air cooled chiller 852 receives PV power (e.g., 12 hours/day (h/d) during the summer and 8 h/d during the winter) from a power supply 854 and outputs chilled makeup water 856 to the TES water tank 858. The TES water tank 858 provides a chilled water supply 860 or a warm water supply 862, depending on the season, to the greenhouse 864.

The filtered air is routed to the bottom of a corrosion resistant upflow section (square epoxy coated concrete, round fiber reinforced plastic—FRP, PVC etc) which may be filled with either polypropylene or other plastic packing (structured or random). SWRO concentrate is routed to a distributor at the top of the packed section and flows downward, countercurrent to the air. The hot dry air is cooled and saturated and the SWRO concentrate is further concentrated until the SWRO concentrate is near saturation (>90% saturated with NaCl). No brine recirculation is used to allow pure countercurrent flow, thereby enhancing (e.g., maximizing) water evaporation and producing a nearly saturated brine. Scaling is prevented because the SWRO feed water is a slightly acidic (e.g., pH between approximately 5 to approximately 6), NF permeate (low hardness) which has been acidified and degasified (near zero alkalinity—<10 mg/l HCO₃). The saturated brine drains by gravity to an underground sump (e.g., fluid container), as shown in FIG. 6, where it is pumped to a storage tank to await nightly return to the desalination plant (e.g., the SWRO brine 25% storage as shown in FIG. 18.)

The cooled nearly saturated (>90% relative humidity) air is sprayed with a small amount of desalinated water (<1% of the evaporated water flow) in an efficient hollow cone spray to contact and wash out the small amount of SWRO concentrate mist from the packed section. The spray water containing the SWRO concentrate mist is combined with the feed SWRO concentrate flowing down the packing. The cleaned very nearly saturated (>95% relative humidity) is routed to a demister pad (optional) to remove any desalinated water mist. The cooled, cleaned, demisted air is routed to a damper system which routes the air to either vent (winter) or a greenhouse (summer). A portion of this cooled air can also be optionally routed to a supplemental mechanical cooling system (described below), or a separate dedicated SWRO concentrate evaporator can be used for mechanical cooling. CO₂ from a chilled ammonia system (described below) can be optionally added to the air routed to the greenhouse to enhance crop yield. CO₂ concentrations up to 1000 ppm can be used in the greenhouse feed air, which can increase the rate of photosynthesis by approximately 50% versus ambient conditions (340 ppm). Brine concentration membranes and/or MVR brine evaporators producing desalinated water and nearly saturated brine may also be used in winter and the evaporator shutdown, if there is low cost excess winter PV power available.

In order to provide sufficient greenhouse cooling in elevated humidity ambient conditions optional supplemental cooling may be provided. The supplemental cooling system uses a heat pump (optionally reversible for greenhouse winter heating) to produce chilled water for a thermal energy storage (TES) system during daytime operation. Cooled air from SWRO concentrate evaporation is used to condense the heat pump fluid (e.g., a refrigerant) which significantly improves the capacity and efficiency of the heat pump during high ambient daytime conditions when low cost PV power is available. The chilled water from the TES system is used in a portion (e.g., 5-50%) of the air movers that are equipped with cooling and/or heating coils and bypass the evaporator (i.e., directly discharge to the greenhouse). The discharge from these air handlers is cooled similar to or below the evaporator outlet temperature, but has a much lower humidity than the evaporator outlet since no evaporated water is added to cool the air. If greenhouse heating is utilized during winter conditions then a damper system (not shown) is used to route daytime ambient air to the heat pump which operates in heating mode (reversed refrigerant flow from chilling) using PV power to produce warm water in the TES tank for night heating. The warm water in the TES tank is used in the air handler heating coils to reheat and circulate cool greenhouse air to provide warm air to the greenhouse during cold winter nights. Minimal greenhouse air is vented, and sufficient air is recirculated through the air handler with heating coils to keep the greenhouse above the minimal desired winter night temperature (between 50-60 F, 10-16° C.).

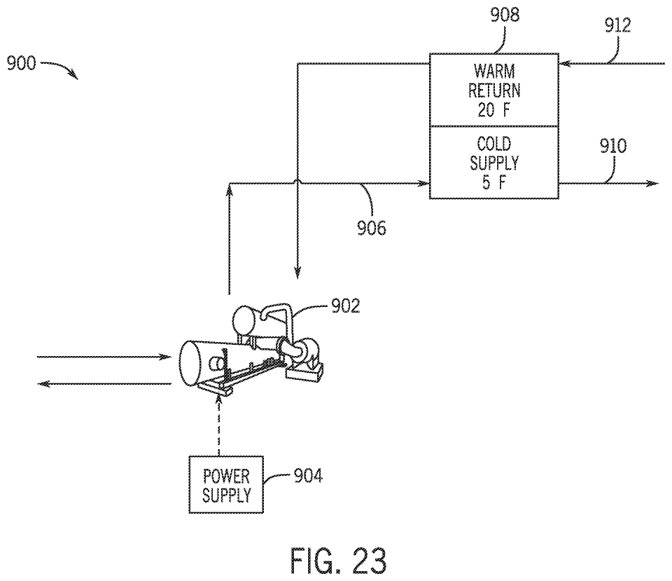

A low temperature TES system may optionally be used to provide refrigeration for Controlled Atmosphere (CA) storage and transportation of the greenhouse crops, as shown in FIG. 23. The low temperature TES system uses chilled water from the main TES system described above and a second water-water chiller (heat pump) operating on PV power (e.g., during daytime operation) to produce a low temperature (e.g., 5-40 F, −15-5° C.) fluid (glycol water, brine, or water) which is stored in a separate low temperature TES tank. This low temperature fluid is used with a high recirculation (>95%) chilled air handler to control the temperature in the CA facility to the desired storage temperature (e.g., between 32-60F, 0-15° C.). Nitrogen from an air fed pressure swing absorber (PSA) or membrane system and low pressure—LP (5-15 psig, 0.3-10 bar) CO₂ from the CO₂ stripping may be added to the CA facility to control oxygen and CO₂ levels. A regenerable, carbon based absorber can optionally be used with a vent to the greenhouse air supply to remove excess CO₂ or to allow for CO₂ removal and reuse during crop loading and unloading from the CA facility.

In the depicted embodiment of the TES system 900 of FIG. 23, a chiller 902 receives photovoltaic power from a power supply 904 and directs a chilled brine/glycol solution 906 to a TES water tank 908. In turn, the TES water tank 908 outputs a chilled brine/glycol supply 910 to the greenhouse (e.g., greenhouse 864) and receives the liquid via return line 912.

A vertical farm building using the SWRO concentrate TES system to heat and cool the building may also be used using a well-insulated building and high (>90%) recirculation air movers may also be used. Humid cooled air from the SWRO concentrate evaporator and heated or cooled ambient air using water from the TES system can be used to supply conditioned air to the building at a target temperature and humidity. An energy recovery ventilator may be used to recover heat or cooling from the exhausted air into the makeup air. LP CO₂ may be added to the circulating air to maintain a slightly elevated CO₂ concentration (350 to 1000 ppm) to enhance plant growth without risk to workers (5000 ppm OSHA permissible exposure limit for 8 hour work period).

### Protected Agriculture

The summer greenhouse air residence time may be limited to 1-2 minutes. This avoids significant solar heating (e.g., <5 F, −15° C.) of the cooled air in the greenhouse, and produces a significant vent stream that is cooler and more humid than the typical arid plateau ambient air conditions. In order to enhance (e.g., maximize) the value of the cooler, more humid vent stream, the vent stream can be further utilized to reduce desalinated irrigation water consumption. A low cost shade cloth system as described below can be used to enhance (e.g., maximize) the value of the greenhouse vent stream to increase crop yield and reduce (e.g., minimize) desalinated irrigation water consumption.

Colored or aluminized shade cloth may be used to cover the top and sides of a large protected area (e.g., 5-10 time more area than the greenhouse). The shade cloth type and shade percentage is controlled (e.g., optimized) to reduce solar heating and enhance (e.g., maximize) crop yield (e.g., by reducing, mitigating, and/or substantially eliminating thermal stress). The shadow cloth also serves to trap the cooler, moist air by preventing ambient turbulence (wind) from introducing hotter, dryer ambient air. Supplemental CO₂ may optionally be injected at the greenhouse vents (shade cloth inlet air) and at addition points within the shade cloth area to maintain a sufficient level of CO₂ content in the air (340-1000 ppm) for effective (e.g., maximum) photosynthesis and crop yield. CO₂ injection near ground level may be advantageous since CO₂ is heavier than air and lower level injection reduces (e.g., minimizes) diffusion losses through the shade cloth. Greenhouse exhaust fans and shade cloth circulation and exhaust fans may be used to maintain near balanced pressure between the ambient air and the air under the shade cloth (between +0.1″ and −0.1″ of water differential pressure) to reduce (e.g., minimize) loss of cool CO₂ rich air through the shade cloth or diffusion of hot, dry ambient air into the shaded area.

Valuable crops that can be grown within the cooler, more humid, CO₂ enriched atmosphere conditions include citrus, red clover, alfalfa, soybeans, or other crops suited for the cooler more humid conditions. In addition to enhancing (e.g., maximizing) yield and reducing (e.g., minimizing) desalinated water consumption, the cooler air and shade cloth also provide an enhanced work environment for workers performing cultivation and harvesting tasks. As discussed below seawater cooled dairy barns may be co-located adjacent to red clover or alfalfa production. This allows morning and evening pasture grazing which increases milk yield, decreases cow watering requirements, and decreases feeding costs. In some embodiments, onsite dairy barns used if alfalfa or red clover pasture/silage grown under the shade cloth instead of citrus. It should be noted that CO₂ purge of silage may reduce (e.g., minimize) oxygen (e.g., aerobic bacteria) losses.

### Dairy and Poultry Barn

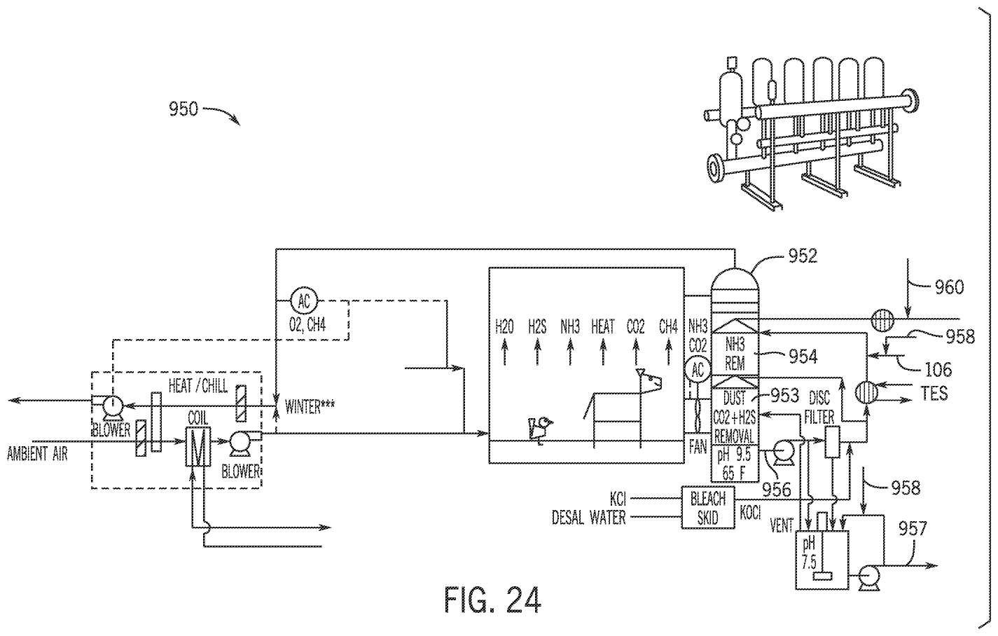

In addition to providing cooling to a greenhouse the SWRO concentrate cooled supplemental TES system may be used to provide cooling to co-located dairy or poultry barns, as shown in the livestock system of FIG. 24. The livestock system 950 includes a scrubber 952 (e.g., scrubber and dehumidified) with a high recirculation rate (>90%) that is used to cool and scrub the air from the dairy or poultry barn (e.g., directed into the scrubber via the fan). The scrubber consists of a dust, CO₂ and H₂S removal zone 953 and ammonia removal lower zone 954 (e.g., ‘NH3 rem’) which recirculates the scrubber sump liquid (pH 9.5 and 65 F, 18° C.) through a regenerable disk filter to remove solids and then through a spray nozzle at the top of the lower zone. A purge 956 is taken from the lower zone of the scrubber which is routed to an organic fertilizer tank along with the backflush from the disk filter. The organic fertilizer 957 may be used in the greenhouse. A portion of the filtered sump liquid is chilled to 50-60 F using supplemental TES system chilled water and makeup desalinated water mixed with sulfuric or dilute (<10 wt %) nitric acid 958 is added to maintain sump level and reduce the liquid pH to 5. Dilute nitric acid and pH control of the scrubbing liquid to pH 5 is preferred to eliminate the chance of NOx or nitric acid mist release into the barn and to provide nitrate, a crop nutrient in the organic fertilizer purge stream discussed above. The chilled acidic liquid is fed to a packed middle section to remove residual ammonia in the air from the lower zone. A portion of the moisture in the air may also be condensed to control the barn humidity and provide additional makeup water. The liquid from the middle section falls into the lower zone. The scrubbed air from the middle zone is sprayed with a small amount of TES chilled makeup desalinated water to remove any acidic scrubbing liquid mist and is then routed to a demister to remove any spray water mist. Most of the scrubbed cooled air is then directed back to the barn, but a portion is removed to purge methane from the barn. Optionally potassium hydroxide 960 may be added to the makeup desalinated water to increase the wash water pH to >9 to ensure that any residual acidic mist in the air to the demister is neutralized. Potassium hydroxide is preferred over sodium hydroxide since potassium hydroxide forms potassium nitrate in the sump purge stream which is a crop nutrient.

In some embodiments, the chilled purge air from the barn may be routed to an energy recovery ventilator (ERV) which cools the makeup air with the chilled purge air. Sensors in the purge air monitor methane and oxygen content in the purge air. Purge and makeup air flow is controlled to maintain the methane content in the purge air below desired limits, and oxygen above minimum limits. Oxygen enriched air from solar powered ammonia production or from membranes may be optionally added to the inlet air to reduce the purge air flow if minimum oxygen content sets the purge rate.

As discussed above there is a significant benefit to co-locating the dairy barn adjacent to the shade cloth protected zone if red clover or alfalfa (e.g., forage crops) are grown. These include SWRO concentrate based TES cooling, organic fertilizer production from barn scrubber, high moisture content feed (lower cow watering requirements), high milk yield, and lower feeding costs.

### CO₂ Recovery System

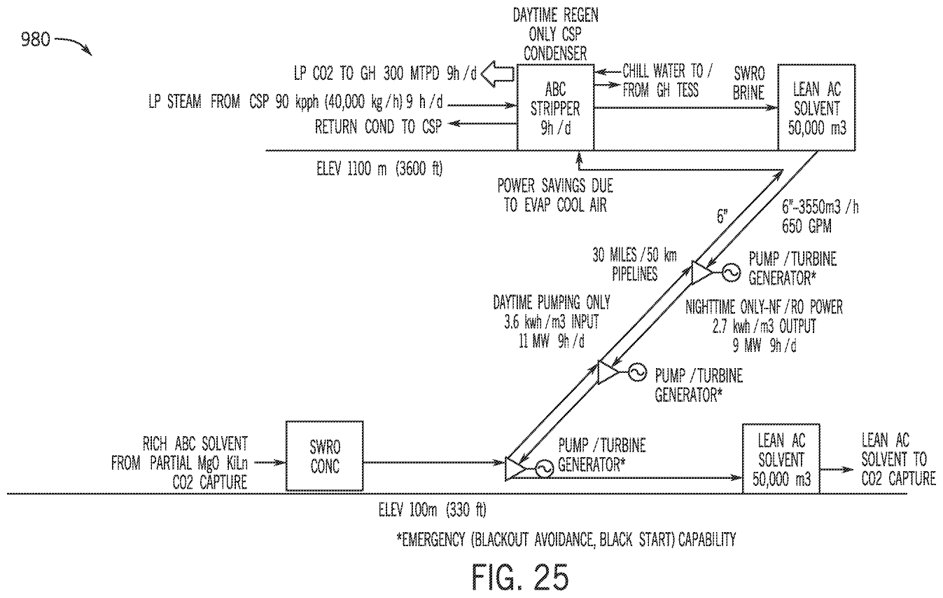

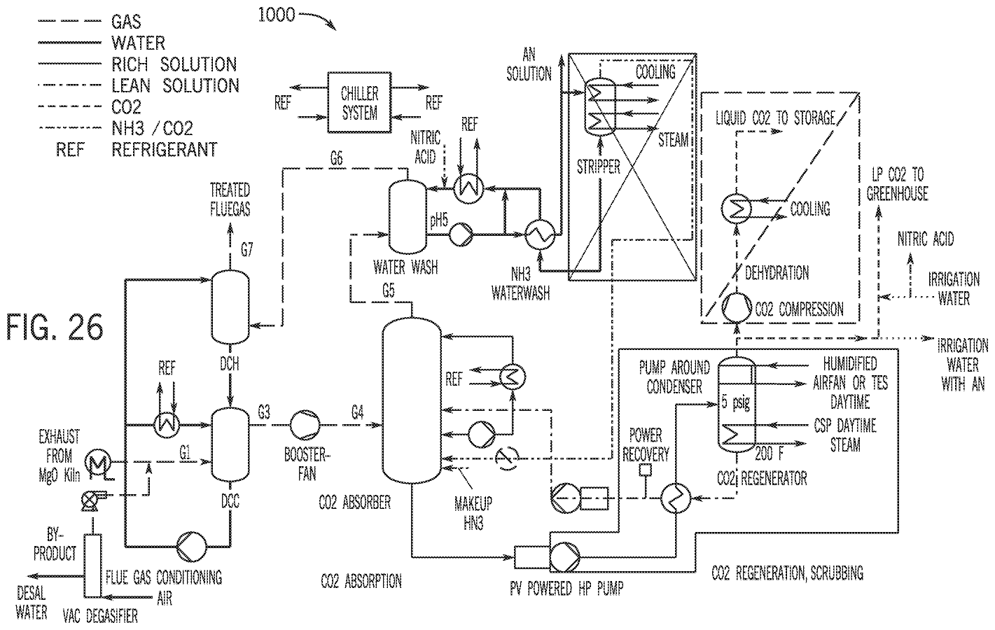

As discussed above CO₂ may be supplied to the greenhouse, shade protected zone, CA storage, and vertical farm building to enhance yield and prevent crop spoilage. FIG. 26 shows a chilled ammonia system 1000 (e.g., which includes generally similar features as shown in FIG. 9) is used to capture CO₂ from the magnesia kiln in the water processing system as described below. The solvent may be provided to the example of a water storage system 980 shown in FIG. 25.

The chilled ammonia absorber system 1000 captures all or a portion of the CO₂, reducing CO₂ emissions from the kiln which operates continuously 24/7. The CO₂ rich solvent is stored in a tank and is pumped during daytime using PV power to a CO₂ stripper located adjacent to the greenhouse. A PV powered chiller with a TES is used to provide a continuous source of chilled fluid for the ammonia absorber system.

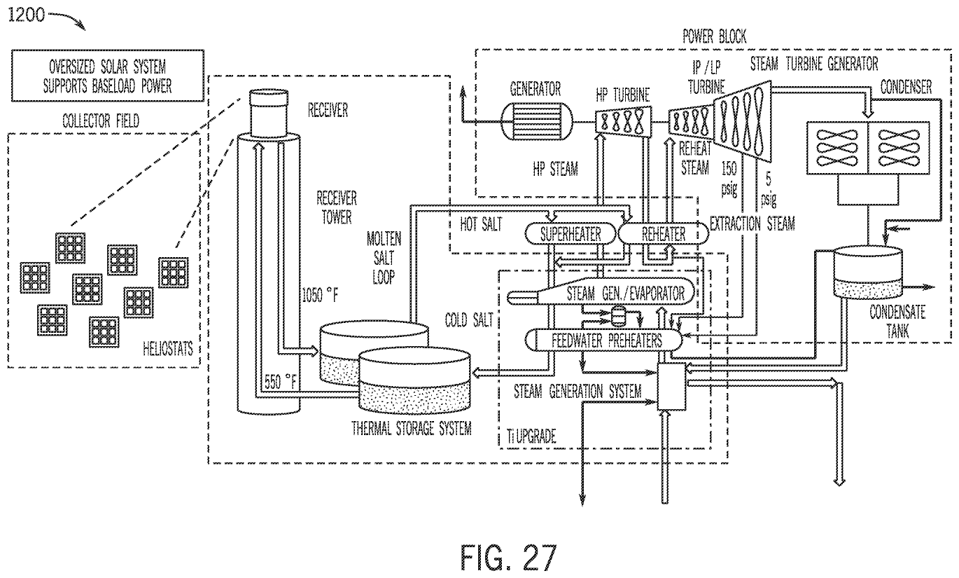

During daytime CO₂ is utilized for the greenhouse, shade protected zone and CA storage makeup. A small (e.g., less than 10% of the total desalination and seawater greenhouse power demand) onsite, baseloaded CSP plant with molten salt or hot oil storage produces power in a steam turbine. For example, FIG. 27 shows an example of a thermal energy system 1200 that may be used to produce power in the stream turbine. During daytime most or all of the steam from the steam turbine is extracted at low pressure conditions (5-50 psig, 0.3-3.4 bar) and is used to provide heat to the bottom of the low pressure (5-30 psig, 0.3-3.4 bar) chilled ammonia CO₂ stripper to convert the CO₂ rich ammonia solution to CO₂ lean ammonia solution. During summer conditions an airfan condenser (preferably a pump around condenser) is used to provide cooling to the top of the CO₂ stripper to recover nearly all of the ammonia solvent. During winter conditions cool water from the greenhouse supplemental TES heating system may be used instead of or in parallel with the airfan condenser. This allows the heat from the daytime stripper operation to be used to heat the greenhouse at night. The stripped CO₂ lean ammonia solvent is stored in a tank so that the stripped CO₂ lean ammonia can be returned at night to the water processing system generating valuable night power, as shown in FIG. 11.

The moisture containing LP CO₂ is routed to a scrubber which uses a portion of the greenhouse irrigation water optionally acidified to pH 5 with sulfuric or dilute (<10 wt %) nitric acid to scrub any residual ammonia from the CO₂. Dilute nitric acid and pH 5 is used to prevent any potential release of NOx or nitric acid mist into the CO₂. Nitric acid may be used because the Nitric acid may be converted to ammonium nitrate in the irrigation which is a crop nutrient. A TES based chilled water exchanger (not shown) may be optionally used to reduce the temperature of the scrubbing water and scrubbed LP CO₂. The LP containing CO₂ is then routed to the various services described above using corrosion resistant FRP or PVC ducting/piping.

The expensive and energy intensive drying, compression, and liquid CO₂ storage is avoided. Storage of the rich and lean solvent provide daytime CO₂ generation (crops may utilize the daytime CO₂ to support photosynthesis) using CSP generated low pressure steam. Although this significantly reduces CSP daytime power production (30-40% reduced power production), the daytime solar power is of low value because the daytime solar power can be replaced with low cost daytime PV power. Nighttime CSP power is unchanged since LP steam is not extracted during nighttime, and the return lean solvent provides additional high value night power.

### CSP Power and SWRO Concentrate Evaporation

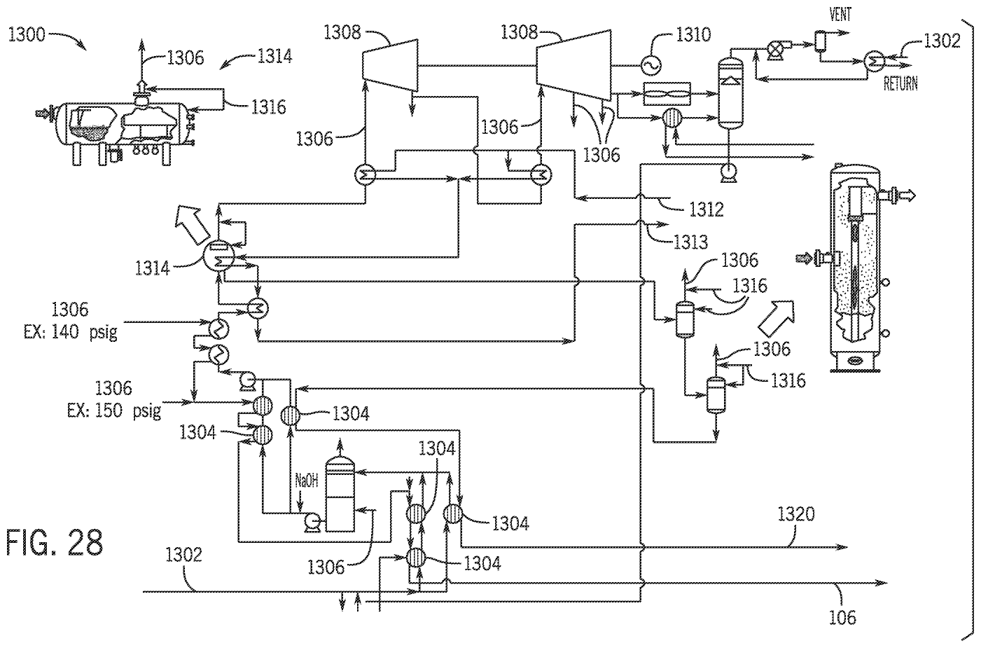

FIG. 28 is a schematic diagram of a solar energy system 1300 that may be incorporated into the water processing system of FIG. 15, in accordance with the present techniques. The SWRO feed water is slightly acidic pH 5-6, NF permeate (low hardness) which has been acidified and degasified (near zero alkalinity). Thus, the SWRO concentrate is essentially non-scaling when the SWRO concentrate is evaporated. This allows the SWRO concentrate to be used once through in the CSP system instead of the typical recirculated closed loop steam condensate. At least in some instances, desalinated water is produced using low pressure (5-15 psig, 0.3-1 bar)) steam extracted from the steam turbine using multi-effect distillation (MED) or multi-stage flash (MSF) evaporation. However, this decreases CSP power production (up to 30%) and requires additional capital for the desalination unit. In addition, these thermal processes are not efficient in evaporating SWRO concentrate to near saturated brine due to the impact of high boiling point elevation for the near saturated brine. The standard CSP steam system design is modified as described below.

As generally depicted in the illustrated embodiment, the solar energy system 1300 receives the SWRO concentrate stream 1302 and directs the SWRO concentrate stream 1302 to one or more heating elements 1304 that produce steam 1306. The steam 1306 produced by the solar energy system 1300 may have a range of pressures. In general, steam 1306 having a relatively high pressure (e.g. greater than 300 psig) may be directed to the turbine 1308 that drives the generator 1310. Steam 1306 having a relatively low pressure (e.g. less than 300 psig, 20 bar) may be condensed to produce desalinated water 106. The solar energy system 1300 may receive hot molten salt 1312 for heating the liquid circulating within the solar energy system 1300, as described in more detail below, and the resulting cooled molten salt 1313 is output to a storage tank. A drum 1314 (e.g., a peerless knock-out (KO) drum with irrigated vane separator) may produce a noncorrosive salt free wet steam 1306 using a receive condensate 1316.

SWRO concentrate may be preheated using product brine from the boiler blowdown flash drums and steam extracted from the steam turbine. Hot oil or molten salt 1312 produced from the CSP mirror system evaporates the preheated SWRO concentrate producing high pressure—HP (1200-1400 psig, 82-96 bar) steam. Preheating the feed reduces the heat of vaporization and allows the hot oil or molten salt to produce additional high pressure steam, increasing both efficiency and steam condensate flow (product desalinated water). A 20 wt % NaCl brine blowdown stream is taken from the HP steam boiler and is flashed to produce medium pressure steam used for SWRO concentrate preheating, and 25 wt % NaCl near saturation brine. Multiple flash stages may be used to decrease the cost of the brine blowdown heat exchangers. The cooled product brine from the SWRO concentrate preheaters is routed to a tank for nighttime release back to the water processing system to generate nighttime power blowdown Titanium heat transfer surfaces are used for the SWRO concentrate preheat exchangers and HP steam boiler to avoid corrosion. This increases costs, but the cost of the material upgrade to the otherwise utilized exchangers is much smaller than the cost and power loss impact of the separate MED or MSF systems.

The steam from the HP steam drum is scrubbed with a small (1-2% of the total steam production) spray of hot steam condensate from the preheaters and a high efficiency demister is used to ensure that essentially no salt is carried over into the steam system. The CSP steam system downstream of the HP boiler remains unchanged (hot oil/molten salt heated superheater and reheater with condensing steam turbine). A dry cooling air fan condenser operating at 10-40 F (e.g., −12 to 4° C.) above ambient air temperature is used to condense the steam under vacuum, thereby enhancing (e.g., maximizing) power production. During winter conditions a TES condenser may be used instead of or in parallel with the air fan to provide warm water to the TES to heat the greenhouse during nighttime. The warm condensate from the condenser is used to preheat the SWRO concentrate and then can be routed to the greenhouse or protected agriculture (shadehouse) area for use as irrigation water.

### Desalinated Water ASR

A portion of the desalinated water pumped to the elevated plateau may be used in an aquifer storage and recovery system 210 (ASR) (e.g., as shown in FIG. 3). The ASR system provides low cost storage of the product desalinated water. The ASR system is significantly large so that seasonal differences in water demand (i.e., high summer demand, low winter demand) do not impact the operation of the water processing system. The water processing system especially those with mineral recovery systems may be operated at 100% rate 24/7 to fully utilize the capital intensive water processing system and the low cost PV power potentially available during winter (low cooling power demand). The ASR also serves as a backup or supplemental desalinated water supply whenever the water processing system is unable to meet desalinated water demand.

The ASR may be operated in conjunction with the pump storage system so that if emergency power is utilized a portion of the ASR water could be released to the return system to generate power.

### Seaweed Production System

Seaweed is an attractive crop for arid regions because seaweed may not utilize fresh water. However, a land based system may be desirable to enhance (e.g., maximize) seaweed yield, reduce (e.g., minimize) labor requirements, and avoid utilization of valuable coastline. In order to reduce (e.g., minimize) aquaculture effluent water treatment, a land based recirculating aquaculture system (RAS) can be used to provide makeup water and nutrients for a land based seaweed greenhouse. The design of this system is described in more detail below.

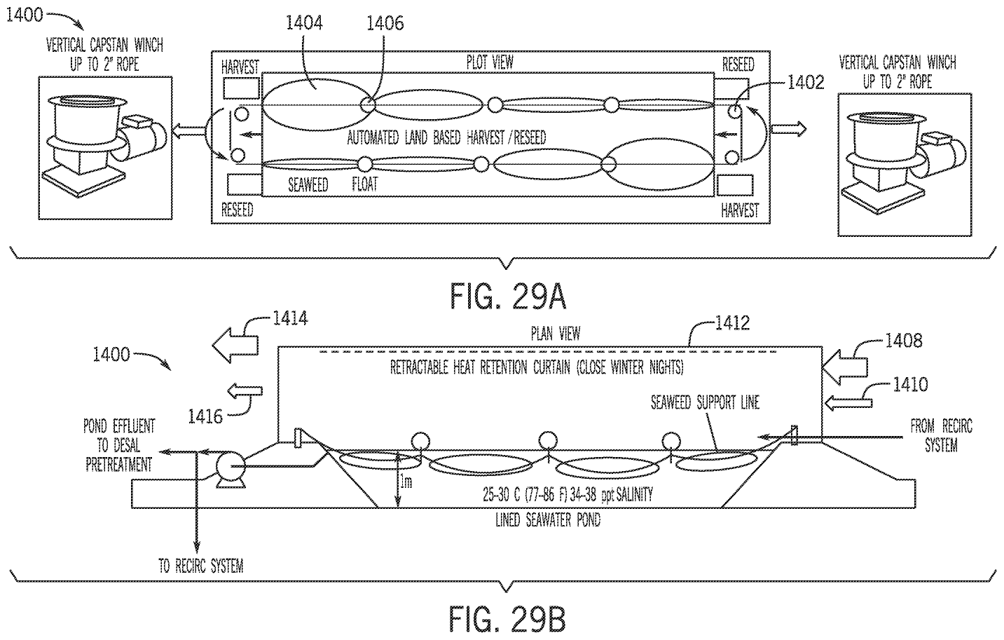

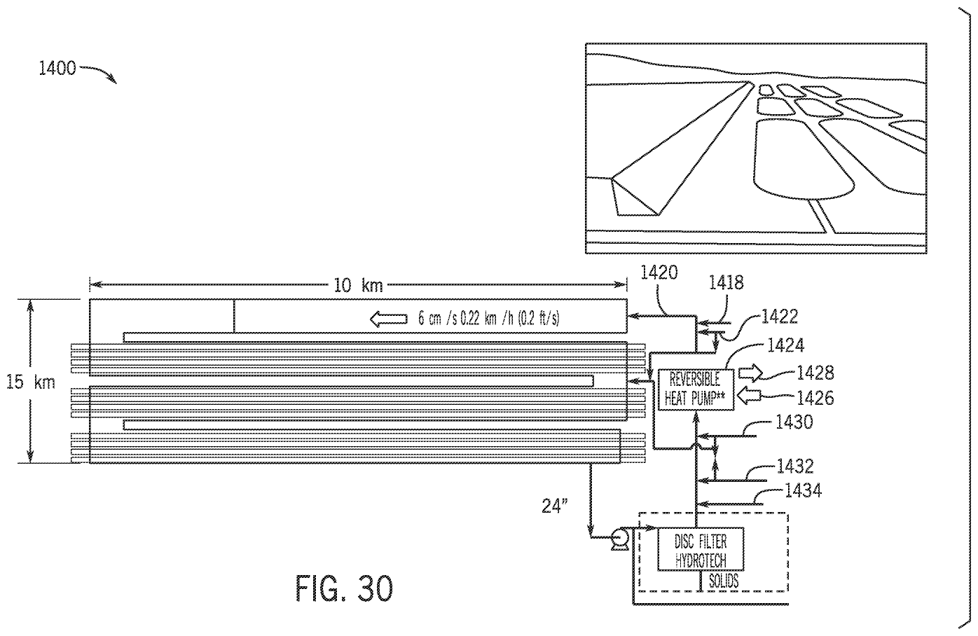

A low cost greenhouse (plastic film, no irrigation system, minimal height, thermal blanket for winter night heat loss reduction) is used to provide temperature and humidity control of the air above the seaweed pond, as shown in FIGS. 29 and 30.

For example, FIG. 29A is an aerial view of the seaweed pond 1400. The seaweed pond may include winches 1402 (e.g. vertical capstan winches) that may hold ropes including seaweed 1404 and floats 1406. FIG. 29B is a cross-sectional view of the seaweed pond 1400. In general, the seaweed pond 1400 may receive a flow of ambient air 1408, 1410 that generally is warmed as it passes through the enclosure 1412 of the seaweed pond 1400 to produce airflows 1414, 1416. For example, the temperature of the ambient air 1408 may be between 70 to 80 F (e.g., 21 to 27° C.), and the temperature of the airflow 1414 may be between 75 and 85 F (e.g., 24 to 29° C.). As another non-limiting example, the temperature of the ambient air 1410 may be between 55 to 70 F (e.g., 12.8 to 21° C.), and the temperature of the airflow 1416 may be between 65 and 85 Fahrenheit.

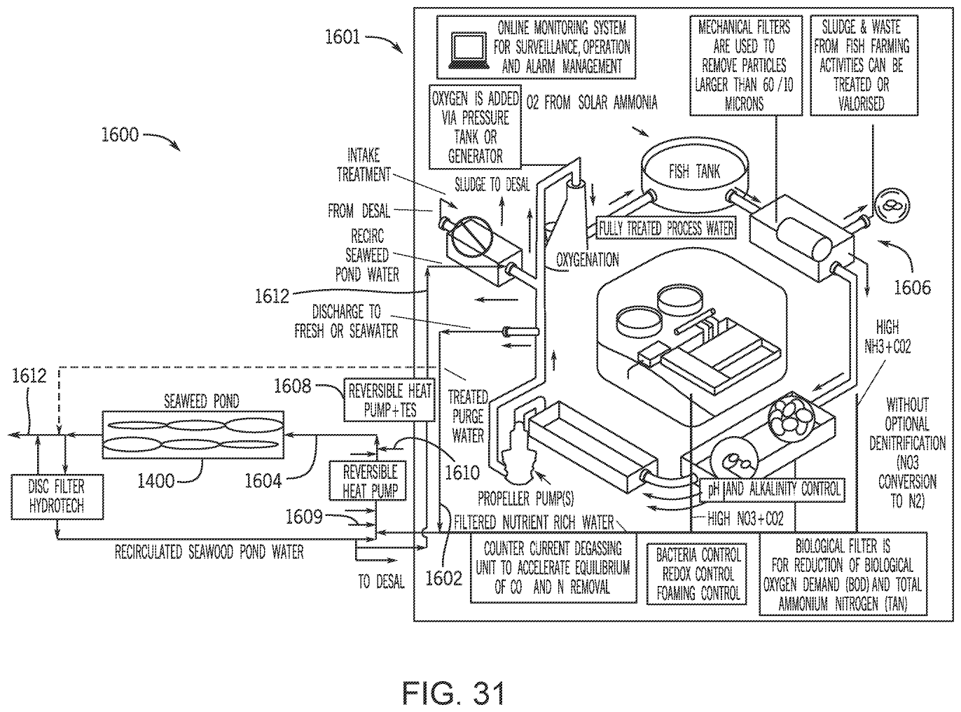

In the illustrated embodiment of FIG. 30, an airflow 1418 (e.g. O₂/air) may be provided to the fluid 1420 flowing into the seaweed pond 1400 and may provide oxidation conditions in the seaweed pond to remove certain contaminants. The fluid 1420 may also receive dolime 1422 for pH control. The heat pump 1424 may receive ambient air 1426 and produce exhaust air 1428 for temperature control of the fluid 1420. CO₂ 1430 may be provided to the fluid 1420 as well. SWRO permeate makeup 1432 and aquaculture effluent 1434 may also be provided to the fluid 1420, as discussed in more detail with respect to FIG. 31.

At least in some instances, the seawater in the pond should be maintained at 77-86 F and the salinity at 34-38 ppt. Winter cooling of the seawater or summer evaporation and concentration of the seawater may be avoided to enhance (e.g., maximize) the high value, tropical seaweed yield. As discussed above an SWRO concentrate evaporator is used to provide cooled moisturized air in the summer to allow pond water temperature control and reduce (e.g., minimize) desalinated makeup water utilized to maintain the target (e.g., optimum) salinity. In winter minimal daytime venting is used, the SWRO concentrate evaporator is routed to vent, and daytime solar heating is used to maintain seawater pond temperature. At night during winter greenhouse thermal curtains may be used to reduce (e.g., minimize) nighttime heat loss from the pond to allow the pond temperature to remain within a threshold temperature range.

Makeup water to the covered seaweed pond may be provided by extracting seawater from multiple locations of a RAS, as shown in FIG. 31. FIG. 31 is a schematic diagram of an aquaculture system 1600, in accordance with the present techniques. Ammonia and CO₂ containing seawater downstream of the filter is used to provide the target (e.g., optimum) amount of ammonia. Nitrate and CO₂ containing seawater from the moving bed biofilm reactor (MBBR) is used to provide the target (e.g., optimum) amount of nitrate and CO₂. It should be understood that certain combinations of organisms may compete for resources within the MBBR. As such, a suitable combination may include organisms that do not compete for resources. For example, denitrifying bacteria (e.g., conversion of carbohydrates and nitrate to CO₂ and N2) may compete with the seaweed for nitrate, whereas ammonia conversion bacteria (e.g., convert ammonia and dissolved oxygen to nitrate) may provide the resources (e.g., nutrients) for the seaweed. An increased RAS purge is desirable instead of denitrifying bacteria to control nitrates since this provides additional seawater and nutrients for the seaweed. Since the limiting nutrients for seaweed are nitrogen (e.g., ammonia and nitrate) and CO₂, the aquaculture effluent water may be utilized as a source of makeup water and nutrients without the denitrifying bacteria (e.g., ammonia to nitrate conversion). In addition to the ammonia+CO₂ and nitrate+CO₂ containing streams, a nitrate stream (stripped seawater) may be fed to the seaweed pond to enhance (e.g., optimize) pH and dissolved CO₂. Alternatively, NaOH may be added to the seawater to control pH and enhance (e.g., maximize) CO₂ and bicarbonate content.

The aquaculture system of FIG. 31 includes a seawater pond (e.g., discussed in more detail with respect to FIGS. 29A, 29B, and 30). The effluent seawater from the seawater pond, which may have a 5-10 day residence time, has a low residual nitrate, ammonia, CO₂ and bicarbonate (e.g., <200% of normal seawater). The effluent seawater from the pond is then routed to the feed seawater stream which is fed to the water processing system. In some embodiments, the nutrients within the stream may be removed prior to being fed back to the water processing system, and thus reducing the load on the water processing system. Optionally a portion of the effluent can be filtered in a disk filter and recycled by mixing with the nutrient rich feed seawater to dilute the nutrient concentration. This may be utilized to prevent parasitic algae growth on the seaweed.

In general, the aquaculture system 1600 of FIG. 31 includes a seaweed pond 1400 that receives a nutrient supply stream 1604 (e.g., fluid 1420) via partial bypass of the biofilter from aquaculture system. The nutrients may be blended to maintain a desired combination of nutrients for seaweed of the seaweed pond 1400. The aquaculture system 1600 may substantially reduce or eliminate unwanted free algae and parasites. For example, the aquaculture system 1600 circulates and filters the liquid in the seaweed pond 1400 and purges organics large to desalination pretreatment dissolved air flotation (DAF) system (e.g., at area 1601) for conversion to organic solid fertilizer at area 1606. That is, the seaweed pond receives treated purge water 1602 and outputs discharged water 1603 to be the DAF system 1601). The aquaculture system 1600 may provide suitable water temperature and chemistry. For example, the reversible heat pump 1608 (e.g., which may be PV powered for daytime heat or cooling) may be used to control the temperature of the seaweed pond 1400. The greenhouse with SWRO concentrate vapor (e.g. summer cooling) may also be used to control the temperature of the seaweed pond 1400. The pH of the seaweed pond 1400 may be controlled with dolime produced by the desalination system described herein. At least in some instances, the solidity of the seaweed pond 1400 may be controlled by the second stage SWRO permeate makeup 1609. In any case, the sunlight and clarity provided to the seaweed pond 1400 may enable approximately 12 harvests per year. In some instances, air 1610 may be provided to the seaweed pond to establish oxidizing conditions in the seaweed pond 1400 (e.g., to substantially reduce or eliminate H₂S). The outlet stream 1612 may be provided to the pretreatment section of the desalination system. The purge (e.g. the outlet stream 1612) may include fishfeed (e.g., greater than 300 L/kilogram) to provide nitrate purge if the seaweed pond 1400 is not operating as expected.

The seaweed pond may be constructed from a low cost plastic lined serpentine pond. The pond is designed so that the seawater velocity is low (6 cm/s-0.22 km/h) and mimics mild sea currents and wave action. This provides the target (e.g., optimal) turbulence at the surface of the seaweed to enable target (e.g., optimum) nutrient supply to the seaweed and avoid a depleted nutrient boundary layer. The low velocity is sufficient to provide enhanced (e.g., optimal) nutrient delivery, without negatively impacting seaweed, thereby obviating extensive seawater pumping and recirculation. The seaweed is attached to a much slower moving rope (0.02 km/h). Thus the seawater velocity is essentially constant (0.20-0.24 km/h) independent of rope direction of movement (with the current or against the current).

As mentioned above the seaweed is secured to a buoyed rope, similar to the system currently used in open ocean production, as shown in FIGS. 29 and 30 Synchronized capstan winches (electrical current and rope tension based synchronization) are used to slowly circulate the rope. Each side of the rope has 20 day residence time to allow the seaweed to grow from cutting size and achieve harvest size. The seaweed is harvested continuously from one end of each circular rope and starter cuttings are added to the opposite side of circular rope which are returned to the pond. A seaweed cutting spray system spray, or seawater filled trough is used to ensure that the new seaweed cuttings do not dry out as they are transferred from the harvest side to the cutting return side. A separate climate control cooling system for the harvesting and new cutting attachment area may be used to reduce (e.g., minimize) fresh seaweed spoilage and provide worker comfort. A chilled seawater system may be used to transport the seaweed from the harvesting area to the packing and processing area. At least in some instances, the highest market value for seaweed is achieved when live seaweed in chilled seawater or salt water is shipped to the customers. Alternatively, the seaweed can be dried with heated air, ambient air, or with sunlight or any combination and shipped as a dried product. Another example of an aquaculture system is shown in FIG. 31.

### Additional Technical Effects

Product desalinated water is used in a pumped storage/pipeline system to provide both desalinated water to an elevated low humidity plateau suitable for a seawater greenhouse and to produce nighttime power.

The novel seawater greenhouse design provides both cooled and humidified air to reduce (e.g., minimize) desalinated irrigation water, and a near saturation (>95% salt saturation) uncontaminated brine stream suitable for high purity minerals production in a downstream MVR crystallizer. The seawater greenhouse evaporator is operated during daytime winter and summer and eliminates the need for high capital and high energy consumption brine concentrators (membrane or MVR based).

The combination of a CSP power plant and chilled ammonia system are used to capture CO₂ from the full recovery water processing system and provide low pressure CO₂ to a greenhouse and protected agriculture system. This avoids water processing system CO₂ emissions and increases the seawater greenhouse crop yields. The CSP system provides most of the greenhouse winter heating requirements, all the low pressure steam for the chilled ammonia system, and most of the daytime power utilized by the greenhouse system. There is also enhanced (e.g., maximum) production of high value nighttime power.

SWRO concentrate evaporation and concentration to near saturated brine is also used to provide cooling for Controlled Atmosphere crop storage, dairy and poultry barns and seaweed production. Dairy and poultry barns co-located with the seawater greenhouse also provide organic fertilizer for the greenhouse, reduce the cost of the dairy feed cost, increase milk yield, and reduce dairy cow water consumption.

Seaweed production using RAS effluent water produces high value seaweed and also reduces (e.g., minimizes) pretreatment of the RAS effluent returned to the seawater water processing system.

By using the combination of the improved seawater greenhouse and 10 million m3/d of full recovery desalination capacity (2× existing Saudi Arabia desalination water capacity) operating essentially (>95% of MWh) on low cost PV power, the 12 billion m3/y (33 million m3/d) of non-renewable fossil ground water consumed by Saudi Arabia can be eliminated and $3.5 billion in incremental agricultural revenue realized.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a desalination system configured to generate desalinated water from a seawater stream;
a gas separation and reaction system downstream from the desalination system, wherein the gas separation and reaction system comprises:
a hydrogen (H₂) and oxygen (O₂) production unit configured to generate an H₂ stream and a first O₂ stream electrolytically using the desalinated water;
an air separation unit configured to receive an air flow comprising nitrogen (N₂) and O₂, wherein the air separation unit is configured to generate a second O₂ stream and an N₂ stream based on the air flow; and
a first ammonia production unit fluidly coupled to the H₂ and O₂ production unit and to the air separation unit, wherein the ammonia production unit is configured to generate an ammonia stream using the N₂ stream and the H₂ stream; and
a second ammonia production unit fluidly coupled to the H₂ and O₂ production unit, wherein the second ammonia production unit is configured to receive a natural gas stream, the first O₂ stream, and an additional air flow, and to generate ammonia based on the gas stream, the additional air flow, and the first O₂ stream.

2. The system of claim 1, wherein the gas separation reaction system is at least partially powered by a solar power energy source.

3. The system of claim 2, comprising a controller, wherein the air separation unit comprises a plurality of air compressors each configured to compress the air flow, and the controller is configured to reduce an operating capacity of a first air compressor of the plurality of air compressors when the solar power energy source is not actively receiving sunlight.

4. The system of claim 1, wherein the second ammonia production unit is configured to receive the first O₂ stream via one or more storage vessels.

5. The system of claim 1, comprising an ammonium phosphate production unit configured to:
receive the desalinated water, a phosphoric acid stream, and the ammonia stream from the first ammonia production unit; and
generate an ammonium phosphate stream based on the desalinated water, the phosphoric acid stream, and the ammonia stream;
wherein a pressure of the ammonium phosphate production unit is maintained within a pressure threshold range to substantially inhibit the ammonia from evaporating.

6. The system of claim 1, comprising an ammonium nitrate production unit configured to:
receive the desalinated water, a nitric acid stream, and the ammonia stream; and
generate an ammonium nitrate stream based on the desalinated water, the nitric acid stream, and the ammonia stream;
wherein a pressure of the ammonium nitrate production unit is maintained within a pressure threshold range to substantially inhibit the ammonia from evaporating.

7. The system of claim 1, comprising a CO₂ recovery system, wherein the CO₂ recovery system comprises:
a chilled ammonia absorber system configured to receive the ammonia stream and an exhaust gas stream, and to generate a CO₂ rich ammonia solution based on the ammonia stream and the exhaust gas stream; and
a CO₂ stripper configured to generate a CO₂ lean ammonia solution and a CO₂ stream based on the CO₂ rich ammonia solution.

8. The system of claim 1, wherein the desalination system comprises a nanofiltration (NF) system disposed upstream of a reverse osmosis (RO) system, wherein the NF system is configured to output an NF non-permeate stream based on the seawater stream, and wherein the RO system is configured to output the desalinated water.

9. The system of claim 8, comprising a mineral removal system disposed downstream from and fluidly coupled to the NF system, wherein the mineral removal system is configured to receive the NF non-permeate stream and to output an overflow stream.

10. The system of claim 1, comprising an underground liquid storage system disposed downstream of an RO system of the desalination system.

11. A system, comprising:
an ammonia production system, comprising:
a first ammonia production unit configured to produce a first ammonia stream using water as a first hydrogen gas source, wherein hydrogen gas of the first hydrogen gas source is electrolytically separated from the water; and
a second ammonia production unit configured to produce a second ammonia stream using natural gas as a second hydrogen gas source; and
an ammonium salt production unit fluidly coupled to the ammonia production system, wherein the ammonium salt production unit is configured to:
receive desalinated water, receive an acid stream, and receive an ammonia stream comprising the first ammonia stream, the second ammonia stream, or a combination thereof; and
generate an ammonium salt stream based on the desalinated water, the acid stream, and the ammonia stream;
wherein a pressure of the ammonium salt production unit is maintained within a pressure threshold range to substantially inhibit the ammonia from evaporating.

12. The system of claim 11, wherein the ammonia production system comprises an oxygen storage vessel configured to receive oxygen produced using the water; and
a controller configured to control flow of the oxygen produced by the water to the second ammonia production unit based on power supplied to the first ammonia production unit.

13. The system of claim 12, wherein the power supplied to the first ammonia production unit comprises solar power, and the controller is configured to control flow of the oxygen to the second ammonia production unit based on a magnitude of the solar power supplied to the first ammonia production unit.

14. The system of claim 11, wherein the ammonium salt comprises ammonium phosphate, and the acid stream comprises phosphoric acid.

15. The system of claim 11, wherein the ammonium salt comprises ammonium nitrate, and the acid stream comprises nitric acid.

16. The system of claim 11, wherein the water comprises desalinated water, and the system comprises a desalinated water system configured to generate the desalinated water and a brine stream using seawater.

17. The system of claim 16, wherein the brine stream comprises calcium, and the system comprises a mineral removal system configured to generate gypsum based on the brine stream; and
wherein the system comprises a water nutrigation system configured to receive the gypsum.

18. A system, comprising:
an ammonia production system, comprising:
a first ammonia production unit configured to produce a first ammonia stream using water as a first hydrogen gas source, wherein hydrogen gas of the first hydrogen gas source is electrolytically separated from the water; and
a second ammonia production unit configured to produce a second ammonia stream using natural gas as a second hydrogen gas source; and
a CO₂ recovery system, wherein the CO₂ recovery system comprises:
a chilled ammonia absorber system configured to receive the first ammonia stream, the second ammonia stream, or a combination thereof, and an exhaust gas stream, and to generate a CO₂ rich ammonia solution based on the ammonia stream and the exhaust gas stream; and
a CO₂ stripper configured to generate a CO₂ lean ammonia solution and a CO₂ stream based on the CO₂ rich ammonia solution from the chilled ammonia absorber system.

19. The system of claim 18, wherein the CO₂ recovery system comprises a plurality of separators, wherein at least one separator is configured to output a treated flue gas based on the exhaust gas stream.

20. (canceled)

21. The system of claim 18, comprising an ammonium salt production unit fluidly coupled to the ammonia production system, wherein the ammonium salt production unit is configured to:
receive desalinated water, an acid stream, and the first ammonia stream from the first ammonia production unit, the second ammonia stream from the second ammonia production unit, or both;
generate an ammonium salt stream based on the desalinated water, the acid stream, and the first ammonia stream, the second ammonia stream, or both; and
wherein a pressure of the ammonium salt production unit is maintained within a pressure threshold range to prevent the ammonia from evaporating.

22. (canceled)
